(19) United States
(12) Patent Application Publication
(10) Pub. No.: US 2005/0270499 A1
(43) Pub. Date: Dec. 8, 2005

(54) Multiprojection system and method of acquiring correction data in a multiprojection system

(75) Inventors: Kensuke Ishii, Tokyo (JP); Takahiro Toyama, Tokyo (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Olympus Corporation, Tokyo (JP)

(21) Appl. No.: 10/861,134

(22) Filed: Jun. 4, 2004

(51) Int. Cl. G03B 21/26

(52) U.S. Cl. 353/94

(57) ABSTRACT

The present invention comprises a local multiprojection system (LMPS) which projects one image on a screen by using a plurality of projectors and a multiprojection system control server (MPSCS) connected with this LMPS through a network, the MPSCS comprises an analysis supporting section which supports analysis of a state of the LMPS and a correction data acquisition method setting section which sets a method of acquiring correction data in the LMPS. In a state that the MPSCS and the LMPS are connected with each other through the network, a state of the LMPS is analyzed by using the analysis supporting section, and a method of acquiring correction data of the LMPS is set based on an analysis result by the correction data acquisition method setting section, thereby executing automatic calibration of the LMPS.

### BACKGROUND OF THE INVENTION

1. Field of the Invention

The present invention relates to a multiprojection system which projects one image by using a plurality of projectors as well as a method of acquiring correction data in the multiprojection system.

2. Description of the Related Art

As a multiprojection system (which will be also abbreviated as MPS hereinafter), various kinds of multiprojection systems have been conventionally proposed (see, e.g., Patent References 1 and 2).

In such an MPS, since images are projected on a screen from a plurality of projectors and one image is synthesized, measures must be taken to, e.g., make the irregularities in color or the joints between the projected images unnoticeable.

Thus, the present applicant has proposed such an MPS as shown in FIG. 33 in, e.g., Japanese Patent Application No. 2002-160475 and Japanese Patent Application No. 2002-163080.

This MPS comprises a control section 501 which controls the entire system, an image display section 502 which includes a plurality of projectors and projects images on a screen, an image generating section 503 which generates a test image (calibration image), an image capturing section 504 such as a digital camera which captures a test pattern projected on the screen from the image display section 502, an image correction data calculating section 505 which calculates various kinds of image correction data based on the projected test pattern, and an image converting section 506 which corrects input image data by using the calculated image correction data in order to generate output image data. The image display section 502 projects a test image on the screen by using the plurality of projectors, the image capturing section 504 captures the test image, and the image correction data calculating section 505 calculates various kinds of image correction data, thereby calibrating the MPS.

(Patent Reference 1)

Japanese Patent Application Laid-open No. 1998-301202
   (Patent Reference 2)
Japanese Patent Application Laid-open No. 2001-54131

However, bringing out the maximum image quality of the system by the calibration requires a high degree of expert knowledge and technical know-how, and it is not easy to execute it by a user him/herself. In general, therefore, a system integrator (which will be also abbreviated as an SI hereinafter) who has a high degree of expert knowledge and technical know-how is sent to a user's side in response to a request from the user or at the time of periodic maintenance, and performs the calibration.

However, sending the SI to the user's side in order to perform the calibration is not efficient, rapidly coping with a demand of the user is hard, and an increase in operating cost is concerned.

### SUMMARY OF THE INVENTION

In view of the above-described problems, it is an object of the present invention to provide a multiprojection system in which a calibration of the multiprojection system can be efficiently and rapidly performed and an operating cost can be reduced, and a method of acquiring image correction data in the multiprojection system.

To achieve this aim, according to the present invention defined in claim 1, there is provided a multiprojection system which has a local multi-projection system which projects one image on a screen by using a plurality of projectors and a multiprojection system control server connected to the local multiprojection system through a network,
the multiprojection system control server comprising:
an analysis supporting section which supports analysis of a state of the local multiprojection system; and
a correction data acquisition method setting section which sets a method of acquiring correction data in the local multiprojection system,
wherein, in a state that the multiprojection system control server is connected with the local multiprojection system through the network, a state of the local multiprojection system is analyzed by the analysis supporting section, a method of acquiring correction data of the local multiprojection system is set based on an analysis result by the correction data acquisition method setting section, and automatic calibration is executed.

According to the present invention defined in claim 2, in the multi-projection system set forth in claim 1, the analysis supporting section comprises:
user information including an installation position of the local multi-projection system and a user; and
a database section which stores local multiprojection system configuration information including a projector model, the number of projectors, a projector layout, a screen size, a screen shape, a projection way and hardware information.

According to the present invention defined in claim 3, in the multi-projection system set forth in claim 1, the analysis supporting section comprises a local multiprojection system monitoring section which can monitor an operating status, a state and a circumferential environment of the local multiprojection system.

According to the present invention defined in claim 4, in the multi-projection system set forth in claim 2, the database section comprises a local multiprojection system data accumulating section which continuously accumulates aged changes in projector characteristics in the local multiprojection system so that reference can be made to the projector characteristics.

According to the present invention defined in claim 5, in the multiprojection system set forth in claim 1, the analysis supporting section comprises an image correction data acquisition time estimating section which estimates a time required for calibration of the local multiprojection system.

According to the present invention defined in claim 6, in the multiprojection system set forth in claim 1, the correction data acquisition method setting section comprises a capture parameter setting section which sets capture parameters at the time of acquisition of image correction data in the local multiprojection system.

According to the present invention defined in claim 7, in the multi-projection system set forth in claim 1, the correction data acquisition method setting section comprises a calculation algorithm setting section which sets an image correction data calculation algorithm in the local multiprojection system.

According to the present invention defined in claim 8, in the multiprojection system set forth in claim 1, the correction data acquisition method setting section comprises a calculation parameter setting section which sets parameters for image correction data calculation in the local multiprojection system.

According to the present invention defined in claim 9, in the multi-projection system set forth in claim 1, the local multiprojection system comprises a security level setting section so that a network connection state can be changed in accordance with a security level set in the security level setting section.

Further, according to the present invention defined in claim 10, there is provided a method of acquiring image correction data in a multiprojection system, comprising:
an information collection step of collecting through a network a state of a local multiprojection system which displays a still picture or a moving picture corresponding to an input image signal on a screen by using images projected by a plurality of projectors;
an analysis step of analyzing an acquired current state; and
an image correction data acquisition method control step of setting parameters optimum for the analyzed current state and executing automatic calibration of the local multiprojection system through the network.

According to the present invention defined in claim 11, in the method of acquiring image correction data in a multiprojection system set forth in claim 10, a state and characteristics of the local multiprojection system including at least projector characteristics of the local multiprojection system are continuously accumulated at the information collection step, and
the analysis step includes an accumulated data analysis step of analyzing a current state based on the continuously accumulated projector characteristics.

According to the present invention defined in claim 12, in the method of acquiring image correction data in a multiprojection system set forth in claim 11, the projector characteristics acquired at the information collection step include luminance information of offset light and maximum light emission of the projector, and
aged changes in the luminance information of offset light and maximum light emission are analyzed at the accumulated data analysis step.

According to the present invention defined in claim 13, in the method of acquiring image correction data in a multiprojection system set forth in claim 11, the projector characteristics acquired at the information collection step include luminance information of offset light and maximum light emission of each RGB primary color of the projector, and
aged changes in the luminance information of offset light and maximum light emission of each RGB primary color are analyzed at the accumulated data analysis step.

According to the present invention defined in claim 14, in the method of acquiring image correction data in a multiprojection system set forth in claim 11, the projector characteristics acquired at the information collection step include chromaticity value information of offset light and maximum light emission of each RGB primary color of the projector, and
aged changes in the chromaticity value information of offset light and maximum light emission of each RGB primary color are analyzed at the accumulated data analysis step.

### BRIEF DESCRIPTION OF THE DRAWINGS

In order to bring about a greater understanding of the present invention, a description will be given on the accompanying drawings.

FIG. 1 is a block diagram showing a basic structure of an MPS according to a first embodiment of the present invention;

FIG. 2 is a view showing a concrete structure of the MPS depicted in FIG. 1;

FIG. 3 is a flowchart showing an operation of an MPSCS depicted in FIG. 1;

FIG. 4 shows a structure of a primary part of an example of a projector depicted in FIG. 2;

FIG. 5 is a view showing a structure of a primary part of another example of the projector depicted in FIG. 2;

FIG. 6 is a view showing a structure of a primary part of still another example of the projector depicted in FIG. 2;

FIG. 7 is a view showing a structure of a primary part of yet another example of the projector depicted in FIG. 2;

FIG. 8 is a view showing a structure of a primary part of an example of a douser unit depicted in FIG. 2;

FIG. 9 is a view showing a structure of a primary part of an example of a calibration camera depicted in FIG. 2;

FIG. 10 is a view showing a structure of a primary part of another example of the calibration camera depicted in FIG. 2;

FIG. 11 is a block diagram showing a structure of a primary part of an example of a control section in an LMPS depicted in FIG. 1;

FIG. 12 is a block diagram showing a structure of a primary part of another example of the control section in the LMPS depicted in FIG. 1;

FIG. 13 is a flowchart showing an example of a calibration operation by the MPS according to the first embodiment;

FIG. 14 is a block diagram showing a basic structure of an MPS according to a second embodiment of the present invention;

FIG. 15 is a flowchart showing an outline of an operation of an MPSCS in the second embodiment;

FIG. 16 is a block diagram showing a basic structure of an MPS according to a third embodiment of the present invention;

FIG. 17 is a flowchart showing an outline of an operation of an MPSCS in the third embodiment;

FIG. 18 is a block diagram showing a basic structure of an MPS according to a fourth embodiment of the present invention;

FIG. 19 is a flowchart showing an outline of an operation in an MPSCS in the fourth embodiment;

FIG. 20 is a block diagram showing a basic structure of an MPS according to a fifth embodiment of the present invention;

FIG. 21 is a flowchart showing an outline of an operation of the MPSCS in the fifth embodiment;

FIG. 22 is a flowchart showing an outline of an operation of an MPS according to a sixth embodiment of the present invention;

FIG. 23 is a block diagram showing a structure of a primary part of an MPS according to a seventh embodiment of the present invention;

FIG. 24 is a flowchart showing an outline of an operation of the MPS in the seventh embodiment;

FIG. 25 is a block diagram showing a basic structure of an MPS according to an eighth embodiment of the present invention;

FIG. 26 is a flowchart showing an operation of a primary part of the MPS in the eighth embodiment;

FIG. 27 is a flowchart showing an operation of a primary part according to a ninth embodiment of the present invention;

FIG. 28 is a flowchart showing an operation of a primary part according to a 10th embodiment of the present invention;

FIG. 29 is a flowchart showing an operation of a primary part according to a 11th embodiment of the present invention;

FIG. 30 is a flowchart showing an operation of a primary part according to a 12th embodiment of the present invention;

FIG. 31 is a flowchart showing an operation of a primary part according to a 13th embodiment of the present invention;

FIG. 32 is a flowchart showing an operation of a primary part according to a 14th embodiment of the present invention; and

FIG. 33 is a block diagram showing a structure of an MPS proposed by the present applicant before the present invention.

### DETAILED DESCRIPTION OF THE PREFERRED EMBODIMENTS

The present invention will now be described hereinafter with reference to the accompanying drawings.

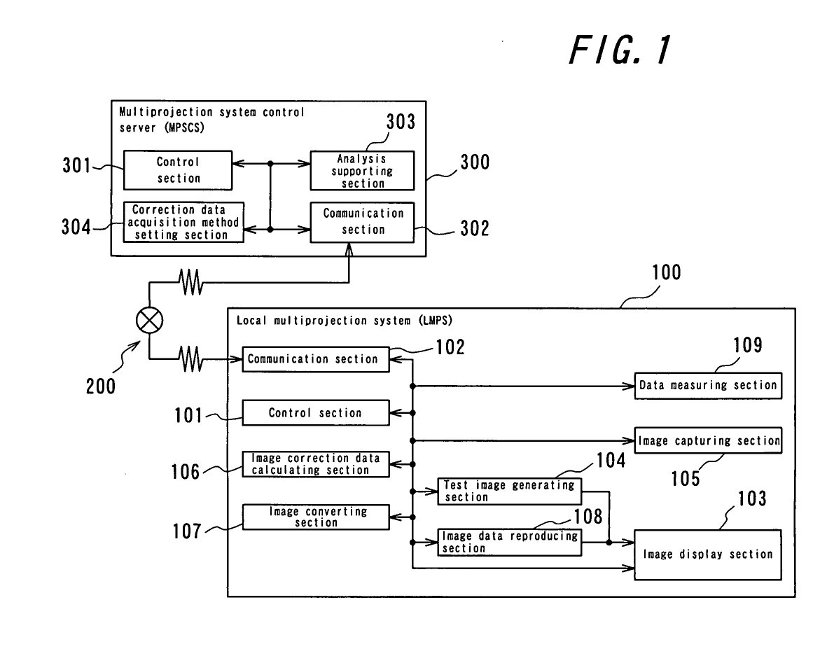

FIG. 1 is a block diagram showing a basic structure of an MPS according to a first embodiment of the present invention.

The MPS according to this embodiment has a local multiprojection system (which will be also abbreviated as an LMPS hereinafter) 100, and a multiprojection system control server (which will be also abbreviated as an MPSCS hereinafter) 300 which is connected with the local multiprojection system through a network 200.

The LMPS 100 has a control section 101 which controls the entire LMPS 100, a communication section 102 which performs communication with the MPSCS 300 through the network 200, an image display section 103 which includes a plurality of projectors and displays images to be projected on a screen, a test image generating section 104 which generates a test image (calibration image), an image capturing section 105 which has a calibration camera which captures a test pattern projected on the screen from the image display section 103, an image correction data calculating section 106 which calculates various kinds of image correction data based on the captured test pattern, an image converting section 107 which converts input image data by using the calculated image correction data, an image data reproducing section 108 which generates output image data to be displayed in the image display section 103 from the converted input image data, and a data measuring section 109 which measures a circumferential environment such as a temperature, brightness and others at a position where the LMPS 100 is set.

Further, the MPSCS 300 has a control section 301 which controls the entire MPSCS 300, a communication section 302 which performs communication with the LMPS 100 through the network 200, an analysis supporting section 303 which supports an analysis of a state of the LMPS 100, and a correction data acquisition method setting section 304 which sets a method of acquiring correction data in the LMPS 100.

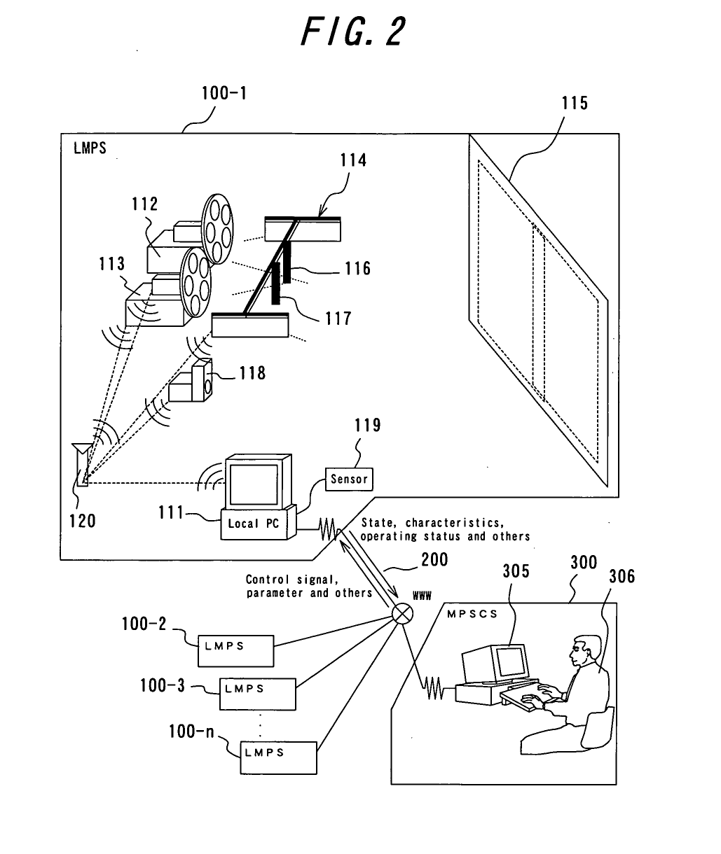

FIG. 2 shows a concrete structure of the MPS in this embodiment. The MPSCS 300 can be selectively connected with LMPS 100-1 to 100-n set at respective sites through the network 200 such as Internet, and is configured to receive various kinds of information such as an operating status, a state, characteristics and others from each LMPS 100 and transmit various kinds of information such as control signals, parameters and others to each LMPS 100. This MPSCS 300 comprises, e.g., a personal computer (which will be abbreviated as a PC hereinafter) 305, and is operated by an SI 306.

Furthermore, the LMPS 100-1 has a local PC 111 constituting the control section 101, the communication section 102, the test image generating section 104, the image correction data calculating section 106, the image converting section 107 and the image data reproducing section 108 depicted in FIG. 1. Moreover, it has a plurality of projectors constituting the image display section 103, which are right and left projectors 112 and 113 in this example, a douser unit 114 and a screen 115, and is configured to display projected images from the projectors 112 and 113 on the screen 115 so that these images partially overlap one another and to adjust a projection light quantity from the corresponding projectors 112 and 113 by using dousers 116 and 117 of the douser unit 114 in order to make a joint between images at the overlapping part unnoticeable. Additionally, the LMPS 100-1 has a calibration camera 118 constituting the image capturing section 105 and a sensor 119 constituting a data measuring section 109.

It is to be noted that, in the LMPS 100-1, the local PC 111, the projectors 112 and 113, the douser unit 114 and the calibration camera 118 can communicate with each other through a wired LAN or a wireless LAN using a TCP/IP protocol or any other general-purpose protocol or a dedicated protocol, but they can communicate with each other by using the wireless LAN through an access point 120 in this example.

The LMPS 100-1 to 100-n are different from each other in structure of the image display section 103, i.e., the number of the projectors, an arrangement type, a size/shape of the screen, a projector mode (LCD, DLP, CRT or the like), a projector model and a lamp operating time of the projector, an LCD operating time in case of an LCD projector and others, and their changes with time are also different from each other.

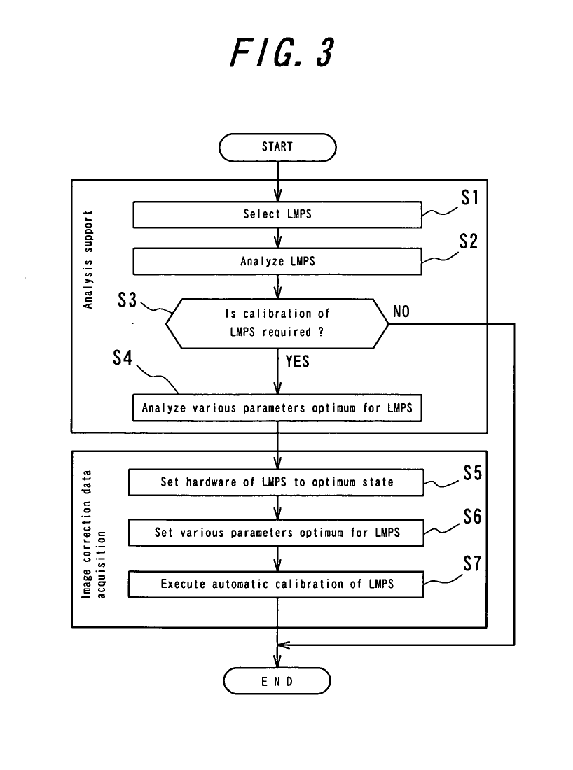

FIG. 3 is a flowchart showing an operation of the MPSCS 300 according to this embodiment. First, an arbitrary LMPS is selected (step S1), a state of the selected LMPS is analyzed (step S2), whether the calibration is required is judged based on an analysis result (step S3), various parameters optimum for this LMPS are analyzed if the calibration is required (if YES) (step S4), and the operation is terminated if the calibration is not required (if NO).

If it is determined that the calibration is required at the step S3 and various parameters optimum for this LMPS are analyzed at the step S4, hardware of the LMPS is optimally set based on an analysis result (step S5), various parameters optimum for the LMPS are set (step S6), and automatic calibration of this LMPS is executed (step S7).

Here, the steps S1 to S4 indicate analysis supporting processing executed in the analysis supporting section 303, and the steps S5 to S7 indicate image correction data acquiring processing executed in the correction data acquisition method setting section 304.

In this manner, the analysis supporting section 303 and the correction data acquisition method setting section 304 are provided to the MPSCS 300, and parameters optimum for a desired LMPS 100 are analyzed/set through the network 200 to automatically perform the calibration, thereby obtaining a high image quality even though the SI 306 is not sent to a site. Further, one MPSCS 300 can be used to manage the plurality of LMPS 100, and hence one SI 306 can manage more LMPS 100.

A description will now be given as to the structures of the respective primary parts of the projectors 112 and 113, the douser unit 114, the calibration camera 118 and the control section 101 in the LMPS 100.

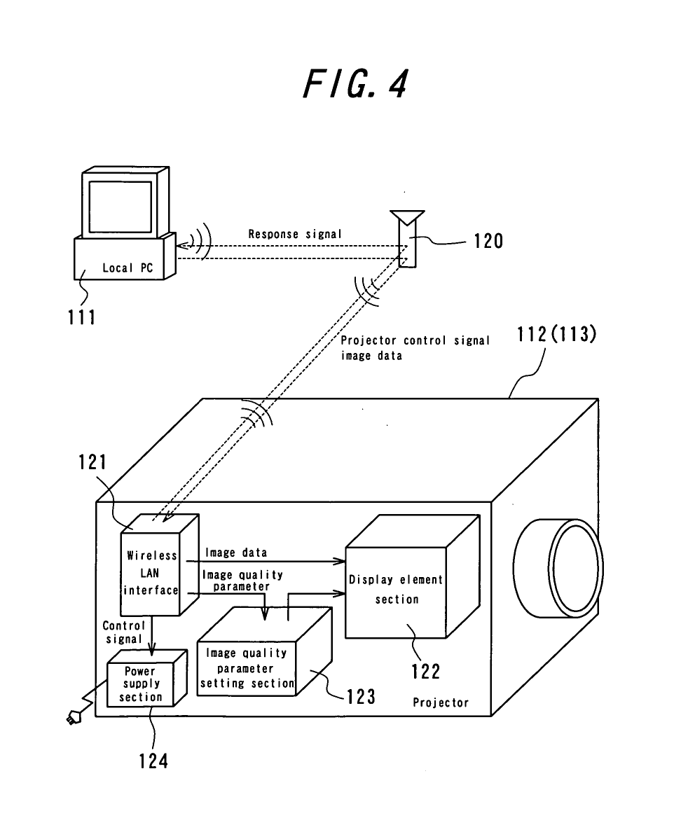

FIG. 4 shows a structure of a primary part of an example of the projector 112. This projector 112 has a wireless LAN interface 121, a display element section 122, an image quality parameter setting section 123 and a power supply section 124, and is configured to receive a projector control signal and image data transmitted from the local PC 111 through the access point 120 by using the wireless LAN interface 121, control the power supply section 124 based on the received projector control signal, set image quality parameters (e.g., an RGB bias value, an RGB gain value, a luminance, a contrast and others) of the display element section 122 through the image quality parameter setting section 123, display the received image data in the display element section 122 and project this data on the screen 115.

Furthermore, the projector 112 transmits a necessary response signal to the local PC 111 from the wireless LAN interface 121 through the access point 120 in response to a transmitted signal from the local PC 111.

The projector 113 is configured like the projector 112.

With such a structure, the projectors 112 and 113 can be individually controlled in the network communication from the MPSCS 300 through the network 200 and the local PC 111. Therefore, for example, when the projectors 112 and 113 are off the luminance balance and an entire contrast as the MPS is degraded, the optimum calibration can be effected by setting the image quality parameters such as an RGB bias value, an RGB gain value, a luminance or a contrast of each of the projectors as desired by the SI 306.

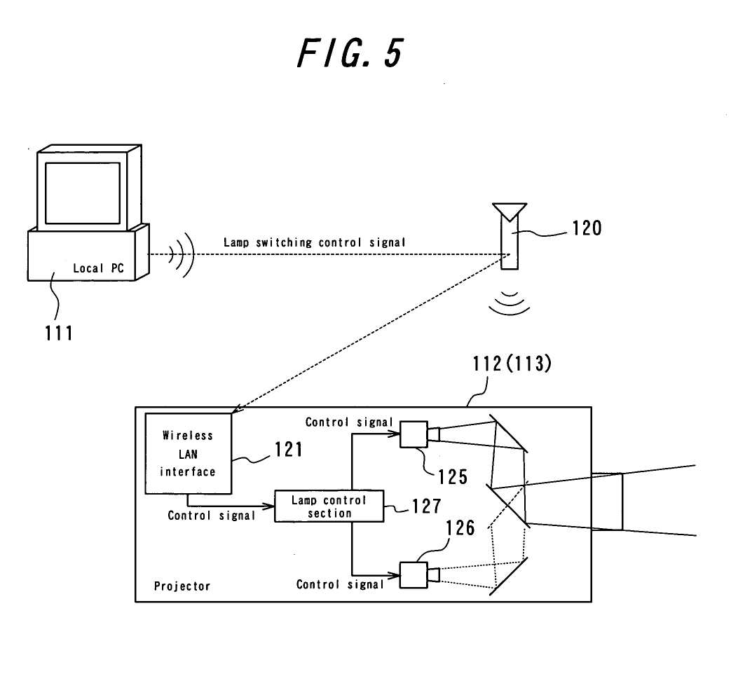

FIG. 5 shows a structure of a primary part of another example of the projector 112. This projector 112 further has two lamps 125 and 126 for projection and a lamp control section 127 which selects one of these lamps in addition to the structure shown in FIG. 4, and is configured to select and use one of the lamps 125 and 126 by the lamp control section 127 based on a lamp switching control signal from the local PC 111 which was received by the wireless LAN interface 121. The projector 113 is also configured like the projector 112.

Providing the two lamps 125 and 126 so that these lamps can be switched enables the lamps to be replaced from the MPSCS 300 through the network 200 and the local PC 111 with a timing desired by the SI 306, thereby effecting the optimum calibration.

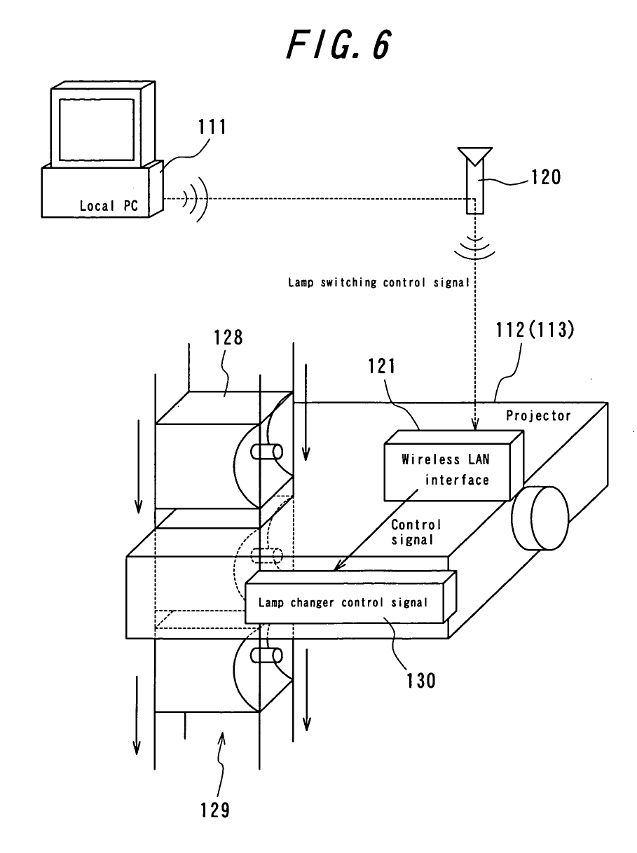

FIG. 6 shows a structure of a primary part of still another example of the projector 112. This projector 112 further has a lamp changer 129 in which many lamp cartridges 128 in which the lamps for projection are accommodated can be set, and a lamp changer control section 130 which controls driving of this lamp changer 129 in addition to the structure shown in FIG. 4, and is configured to drive the lamp changer 129 by using the lamp changer control section 130 based on a lamp switching control signal from the local PC 111 which was received by the wireless LAN interface 121, and place and use one lamp cartridge 128 at a predetermined position. The projector 113 is also constituted like the projector 112.

By providing the lamp changer 128 in this manner, since the lamp cartridge 128 to be used can be replaced from the MPSCS 300 through the network 200 and the local PC 111 with a timing desired by the SI 306, the optimum calibration can be executed. Moreover, many preliminary lamp cartridges 128 can be set in the lamp changer 129, thereby facilitating the maintenance.

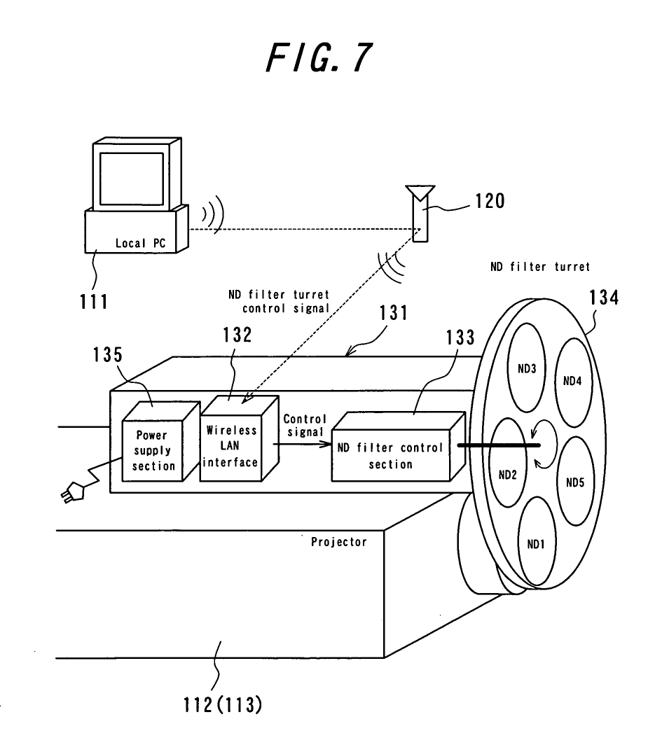

FIG. 7 shows a structure of a primary part of yet another example of the projector 112. This projector 112 has an ND filter unit 131. The ND filter unit 131 has a wireless LAN interface 132, an ND filter control section 133, a rotatable ND filter turret 134 which holds a plurality of (five in this example) ND filters ND1 to ND5 having different transmittances on the same circumference, and a power supply section 135, and is configured to receive an ND filter turret control signal transmitted from the local PC 111 through the access point 120 by using the wireless LAN interface 132, controls rotational driving of the ND filter turret 134 by using the ND filter control section 133 based on the received ND filter turret control signal and position an ND filter having a desired transmittance on a projection light path.

An ND filter unit 131 having the same structure is also provided to the projector 113.

With such a structure, the respective ND filter units 131 of the projectors 112 and 113 can be individually controlled in the network communication from the MPSCS 300 through the network 200 and the local PC 111. Therefore, for example, when the luminance of each of the projectors 112 and 113 becomes irregular, irregularities in the luminance can be reduced by setting an optimum ND filter with respect to each projector by the SI 306, thereby increasing the contrast as the LMPS 100.

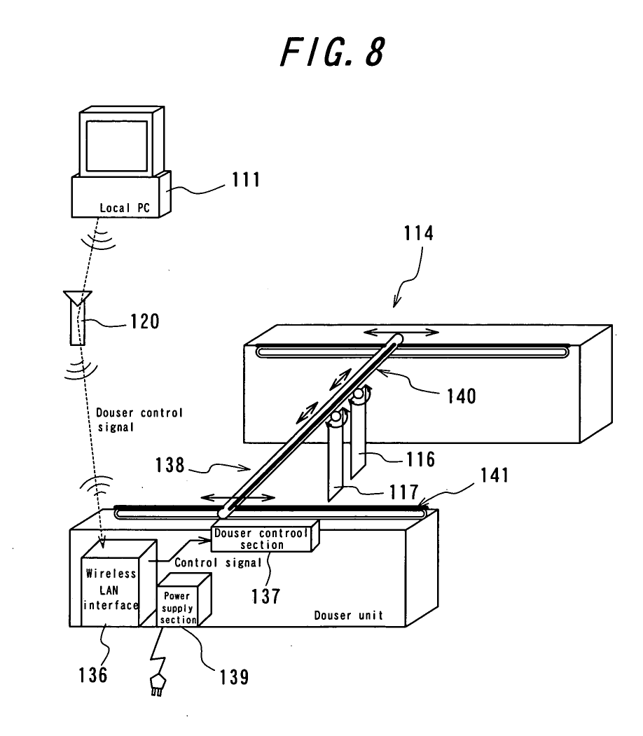

FIG. 8 shows a structure of a primary part of an example of the douser unit 114. This douser unit 114 has a wireless LAN interface 136, a douser control portion 137, a douser drive mechanism 138 and a power supply section 139, and is configured to receive a douser control signal transmitted from the local PC 111 through the access point 120 by using the wireless LAN interface 136, control driving of the douser drive mechanism 138 based on the received douser control signal by using the douser control section 137 and adjust respective projection light quantities from the corresponding projectors 112 and 113 by using dousers 116 and 117.

The douser drive mechanism 138 comprises a clockwise/counterclockwise swiveling drive mechanism 140 and a forward/backward drive mechanism 141, holds strip-like dousers 116 and 117 extending in the vertical direction by using the clockwise/counterclockwise swiveling drive mechanism 140, independently moves these dousers 116 and 117 toward the right and left sides, swivels them around the vertical axis, and moves the clockwise/counterclockwise swiveling drive mechanism 140 forward or backward so as to get closer to or to be distanced from the projectors 112 and 113 by using the forward/backward drive mechanism 141, and adjusts a posture and a position of each of the dousers 116 and 117, thereby adjusting projection light quantities from the projectors 112 and 113.

With such a structure, since the dousers 116 and 117 of the douser unit 114 can be individually controlled in the network communication from the MPSCS 300 through the network 200 and the local PC 111, the dousers 116 and 117 can be set to an appropriate attitude and position desired by the SI 306, thereby effecting the optimum calibration.

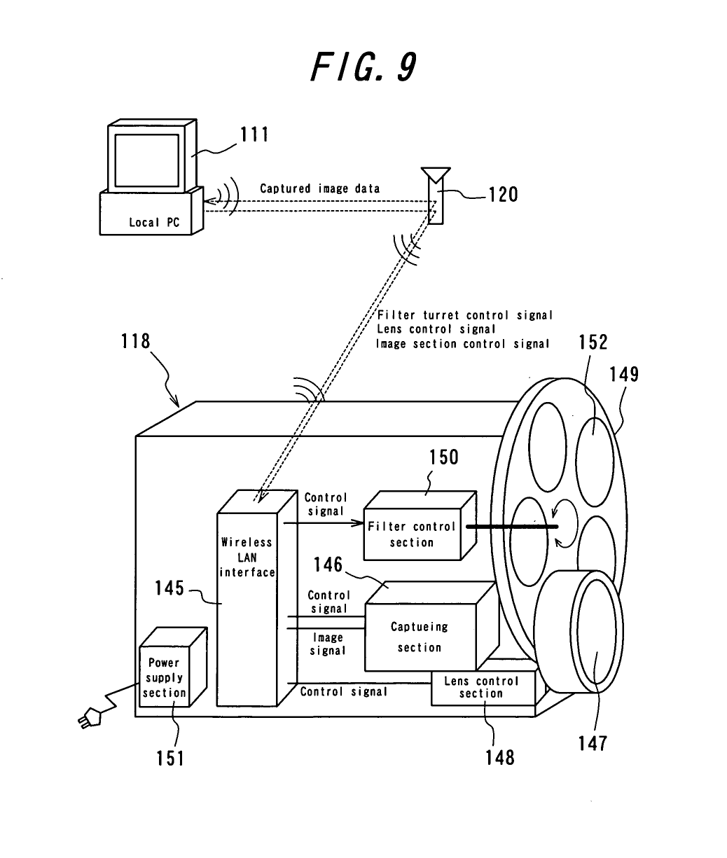

FIG. 9 shows a structure of a primary part of an example of a calibration camera 118. This calibration camera 118 has a wireless LAN interface 145, a capturing section 146, an imaging lens 147, a lens control section 148, a color filter turret 149, a filter control section 150 and a power supply portion 151. This calibration camera 118 is configured to receive in the wireless LAN interface 145 a filter turret control signal, a lens control signal and a capturing section control signal which are transmitted from the local PC 111 through the access point 120, control swiveling of the color filter turret 149 based on the filter turret control signal by using the filter control section 150, control a focal position, an aperture and others of the imaging lens 147 based on the lens control signal by using the lens control section 148, control driving of the capturing section 146 based on the capturing section control signal, and transmit an image signal obtained by capturing in the capturing section 146 as captured image data to the local PC 111 from the wireless LAN interface 145 through the access point 120.

It is to be noted that a plurality of (multi-band) color filters 152 are held on the same circumference of the color filter turret 149, and swiveling of this color filter turret 149 is controlled by the filter control section 150 as described above so that a necessary color filter 152 can be positioned in an imaging light path between the capturing section 146 and the imaging lens 147.

With such a structure, a desired color filter 152 can be selected in the network communication from the MPSCS 300 through the network 200 and the local PC 111, and driving of the capturing section 146 and the imaging lens 147 can be appropriately controlled. Therefore, a calibration test pattern projected on the screen 115 can be captured in an optimum state, thereby accurately performing the calibration. Further, connecting the local PC 111 through the wireless LAN facilitates setting in the LMPS 100.

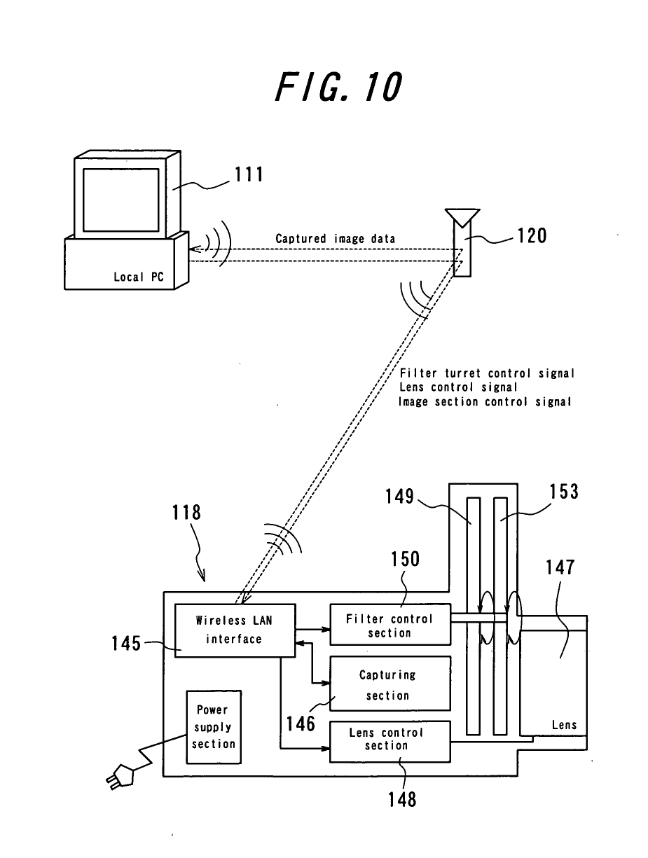

FIG. 10 shows a structure of a primary part of another example of the calibration camera 118. This calibration camera 118 has an ND filter turret 153 added to the structure depicted in FIG. 9. A plurality of ND filters having different transmittances are held on the same circumference of the ND filter turret 153, and this ND filter turret 153 is subjected to rotational control based on a filter turret control signal from the local PC 111 through the wireless LAN interface 145 and the filter control section 150 like the color filter turret 149 so that an ND filter having a necessary transmittance can be positioned in an imaging light path between the capturing section 146 and the imaging lens 147.

By adding the ND filter turret 153 which holds the plurality of ND filters with different transmittances in this manner, an ND filter with a transmittance which enables image capturing with an optimum exposure time to be selected when the RGB luminance becomes off balance between the projectors 112 and 113 due to aging, and hence a calibration test pattern can be always imaged in an optimum state, thereby stably effecting the optimum calibration.

It is to be noted that the calibration camera 118 shown in FIGS. 9 and 10 captures a color image having a test pattern by using the color filter turret 149, but a digital camera including a solid-state image sensing device such as a CCD having, e.g., a Bayer array of the RGB filter can be used as such a calibration camera 118.

FIG. 11 is a block diagram showing a structure of a primary part of an example of a control section 101 in an LMPS 100. This control section 101 has a test image display switching detecting section 155. An image storing section 156, an image difference calculating section 157 and an image switching judging section 158 are provided to the test image display switching detecting section 155, test images (calibration images) are captured at fixed time intervals in the image capturing section 105, the captured images are sequentially stored in the image storing section 156, a difference of the sequential images is calculated by the image difference calculating section 157, switching of the test images is judged based on the calculated difference in the image switching judging section 158, and generation of the test images by the test image generating section 104 is controlled based on a judgment result.

By utilizing the image capturing section 105 which is used for the calibration in this manner, switching of the test images displayed in the image display section 103 can be detected by a simple structure, and hence display and capture of the test image can be assuredly executed even if the SI 306 does not exist at a position where the LMPS 100 is installed.

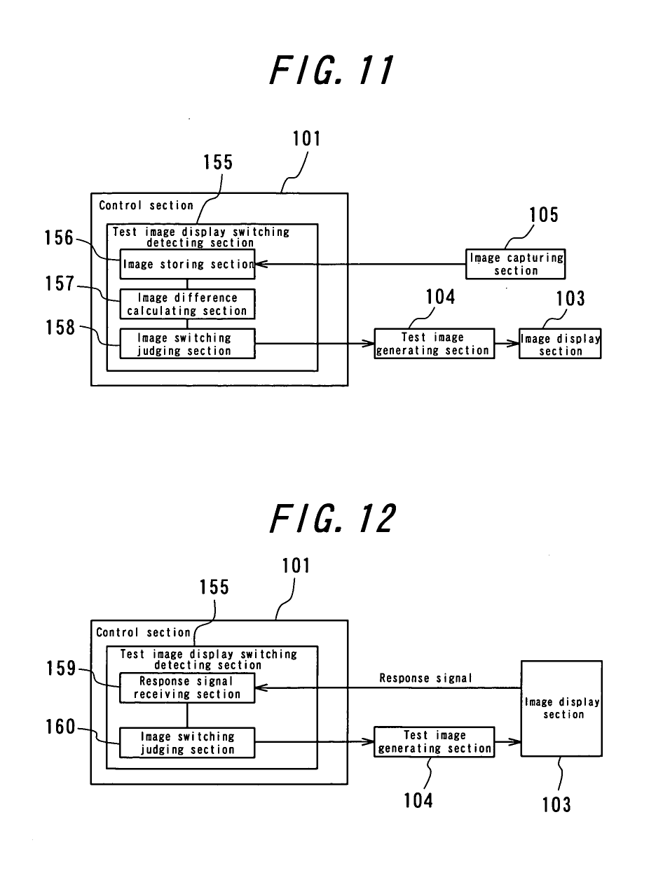

FIG. 12 is a block diagram showing a structure of a primary part of another example of the control section 101 in the LMPS 100. This control section 101 has a response signal receiving section 159 and an image switching judging section 160 provided in the test image display switching detecting section 155, a response signal indicative of display switching of test images is generated from the image display section 103, the response signal is received by the response signal receiving section 159, switching of the test images is judged in the image switching judging section 160 in accordance with acceptance/non-acceptance of the response signal in the response signal receiving section 159, and generation of the test images by the test image generating section 104 is controlled based on a judgment result.

By generating the response signal indicative of display switching of the test images from the image display section 103 and detecting switching of the test images by utilizing this response signal in this manner, switching of the test images can be more assuredly detected, thus further securely executing display and capture of the test images.

It is to be noted that such a test image display switching detecting section 155 as shown in FIGS. 11 and 12 can be provided in the control section 301 of the MPSCS 300 in place of the control section 101 of the LMPS 100.

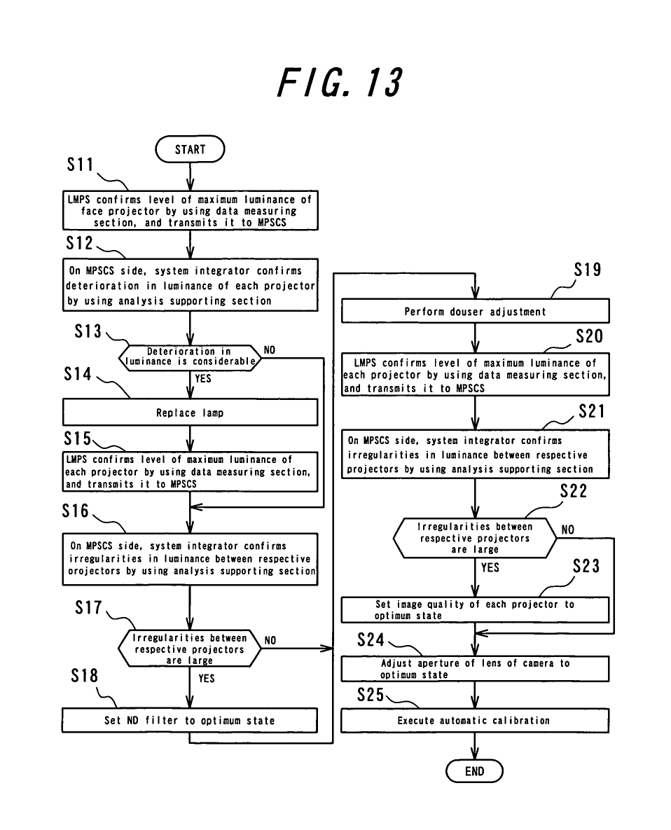

An example of a calibration operation by the MPS according to this embodiment will now be described with reference to a flowchart shown in FIG. 13.

First, a level of a maximum luminance of each projector 112 or 113 is confirmed by using the data measuring section 109 in the LMPS 100, and it is transmitted to the MPSCS 300 (step S11).

Then, in the MPSCS 300, a deterioration in luminance of each projector 112 or 113 is confirmed by the SI 306 using the analysis supporting section 303 (step S12), a judgment is made upon whether the deterioration in luminance is intensive (step S13), replacement of a projection lamp is executed (step S14) if there is a projector in which deterioration in luminance is intensive (if YES), and a level of the maximum luminance of each projector 112 or 113 is again confirmed by using the data measuring section 109 in the LMPS 100 after replacement and transmitted to the MPSCS 300 (step S15).

Subsequently, in the MPSCS 300, irregularities in luminance between the projectors 112 and 113 are confirmed by the SI 306 using the analysis supporting section 303 (step S16), a judgment is made upon whether the irregularities are intensive (step S17), the ND filters of the projectors 112 and 113 are optimally adjusted (step S18) if the irregularities are intensive (if YES), and then the dousers 116 and 117 are adjusted (step S19).

It is to be noted that the processing advances to the step S16 if it is determined that the deterioration in luminance is not intensive (if NO) at the step S13, and the processing proceeds to the step S19 if it is determined that the irregularities between the projectors are not intensive (if NO) at the step S17.

When the dousers 116 and 117 are adjusted at the step S19, a level of the maximum luminance of each projector 112 or 113 is then confirmed by using the data measuring section 109 in the LMPS 100 and transmitted to the MPSCS 300 (step S20).

Thereafter, in the MPSCS 300, irregularities in luminance between the respective projectors 112 and 113 are confirmed by the SI 306 using the analysis supporting section 303 (step S21), whether the irregularities in luminance between the respective projectors 112 and 113 are intensive is judged (step S22), the image quality of each projector 112 or 113 is set to the optimum state (step S23) if the irregularities are intensive (if YES), an aperture of the imaging lens 147 of the calibration camera 118 is adjusted to the optimum state (step S24), and the automatic calibration is executed (step S25).

It is to be noted that the processing advances to the step S24 if it is determined that the irregularities in luminance between the respective projectors 112 and 113 are not intensive (if NO) at the step S22.

As described above, according to this embodiment, even if the irregularities in luminance between the respective projectors 112 and 113 of the LMPS 100 become large due to aging, the irregularities can be diagnosed from a remote site by using the MPSCS 300, and the control over hardware and setting of parameters can be performed, thereby carrying out the optimum calibration.

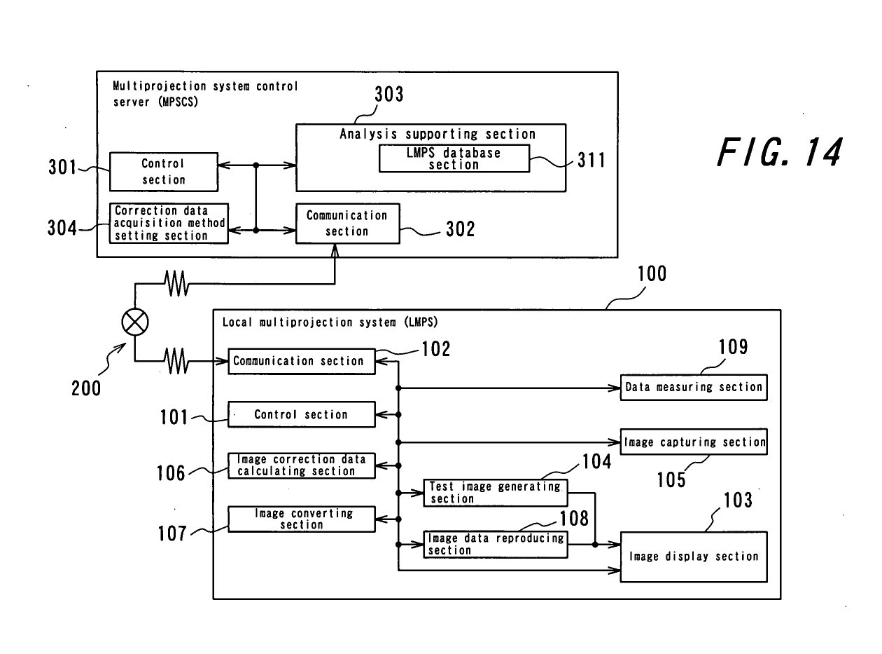

FIG. 14 is a block diagram showing a basic structure of an MPS according to a second embodiment of the present invention.

The MPS according to this embodiment has an LMPS database section 311 being provided to the analysis supporting section 303 of the MPSCS 300 in the first embodiment, and stores in this LMPS database section 311 user information including installation positions of the connected LMPS 100-1, 100-2, . . . , users and others and LMPS configuration information including a projector model, the number of projectors, a projector arrangement type, a screen size, a screen shape, a projection type and information of installed hardware.

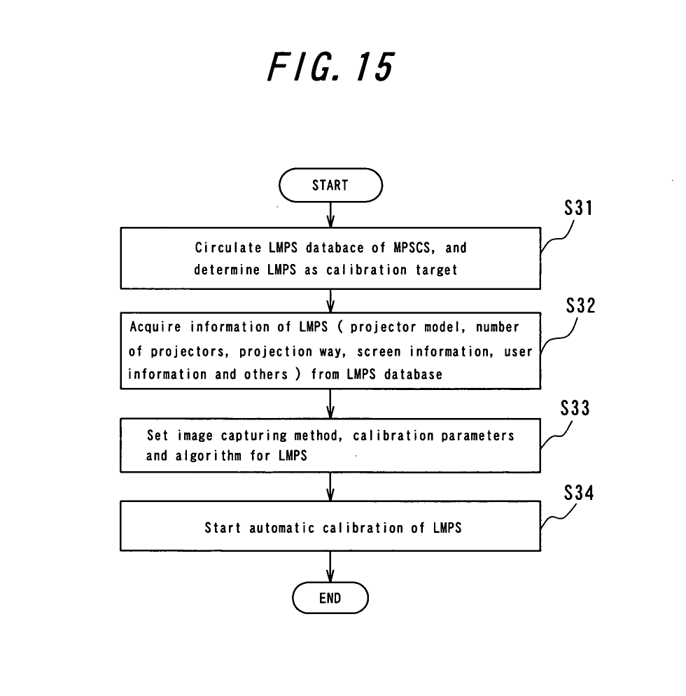

FIG. 15 is a flowchart showing an outline of an operation of the MPSCS 300 according to this embodiment, and this figure shows an operation of acquiring image correction data which is used to perform the automatic calibration by using the LMPS database stored in the LMPS database section 311. First, the LMPS database of the LMPS database section 311 is circulated, and the LMPS 100 as a calibration target is determined (step S31).

Then, information of the determined LMPS 100 (a projector model, the number of projectors, a projection type, screen information, user information and others) is acquired from the LMPS database (step S32), and an image capturing method, calibration parameters and an algorithm optimum for this LMPS 100 are set based on the acquired information (step S33) to start the automatic calibration (step S34).

By setting the LMPS database section 311 to the analysis supporting section 303 of the MPSCS 300 and storing the user information and the LMPS configuration information of each LMPS 100 in this manner, more LMPS 100 can be managed.

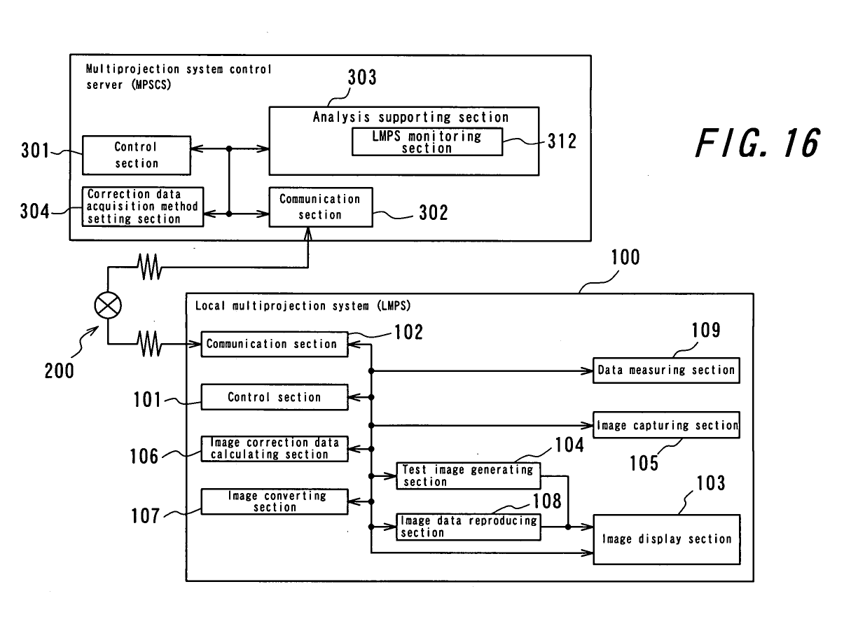

FIG. 16 is a block diagram showing a basic structure of an MPS according to a third embodiment of the present invention.

The MPS according to this embodiment has an LMPS monitoring section 312 being provided to the analysis supporting section 303 of the MPSCS 300 in the first embodiment, and monitoring of an operating status, a state, a circumferential environment and others of the LMPS 100 including monitoring of various kinds of hardware such as projectors of a desired LMPS 100, an installation environment, a state of any other system and the like is performed by this LMPS monitoring section 312 through the network 200.

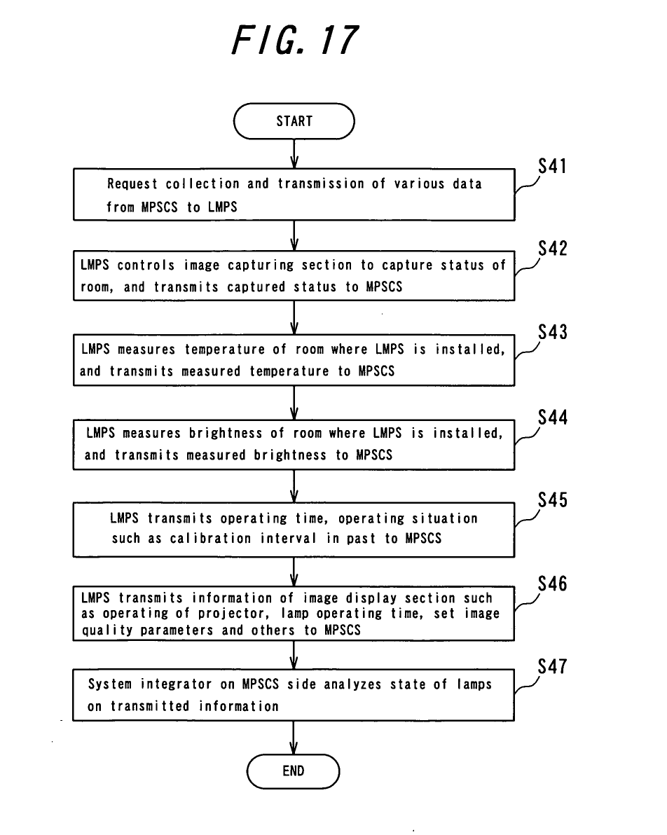

FIG. 17 is a flowchart showing an outline of an operation of the MPSCS 300 according to this embodiment, and illustrates an operation of acquiring image correction data which is used to perform the automatic calibration by utilizing the LMPS monitoring section 312. First, collection and transmission of various kinds of data are requested with respect to a desired LMPS 100 from the MPSCS 300 (step S41).

In the LMPS 100 which has received the request from the MPSCS 300, an image indicating a status of a room in which the LMPS 100 is set is captured by controlling the image capturing section 105 and transmitted to the MPSCS 300 (step S42), a temperature is measured by the data measuring section 109 and transmitted to the MPSCS 300 (step S43), and the brightness of the room is measured by the data measuring section 109 and transmitted to the MPSCS 300 (step S44).

Moreover, the LMPS 100 transmits an operating time in the past or an operating status such as a calibration interval to the MPSCS 300 (step S45), and also transmits information of the image display section 103 such as an operating time of each projector, a operating time of the projection lamp, a set image quality parameter and others to the MPSCS 300 (step S46).

Thereafter, the MPSCS 300 analyzes the state of each LMPS 100 based on the transmitted information by the SI 306 (step S47), and determines a method of acquiring image correction data which is used to execute the automatic calibration.

By providing the LMPS monitoring section 312 to the analysis supporting section 303 of the MPSCS 300 and monitoring an operating status, a state, a circumferential environment and others of a desired LMPS 100 in this manner, a status of a position where this LMPS 100 is installed can be grasped in real time, and hence the operation of analyzing the LMPS 100 by the SI 306 can be efficiently supported.

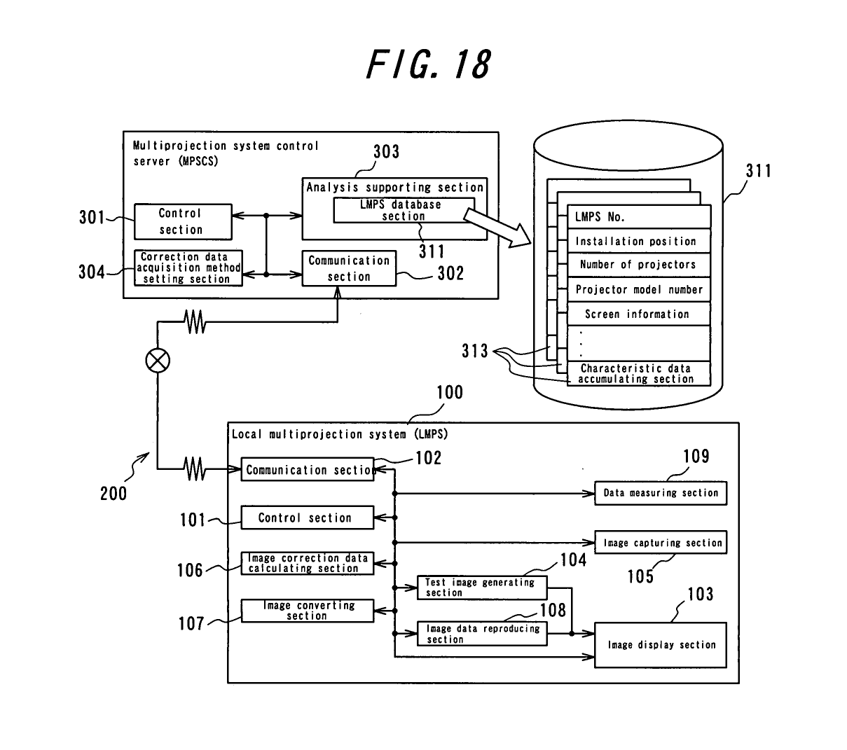

FIG. 18 is a block diagram showing a basic structure of an MPS according to a fourth embodiment of the present invention.

The MPS according to this embodiment has a characteristics data accumulating section 313 as an LMPS data accumulating section being provided to the LMPS database section 311 of the analysis supporting section 303 of the MPSCS 300 in the second embodiment, and changes with time in projector characteristics (luminance or colors in particular) of each connected LMPS 100 are continuously accumulated in this characteristic accumulating section 313 so that reference can be made to the projector characteristics.

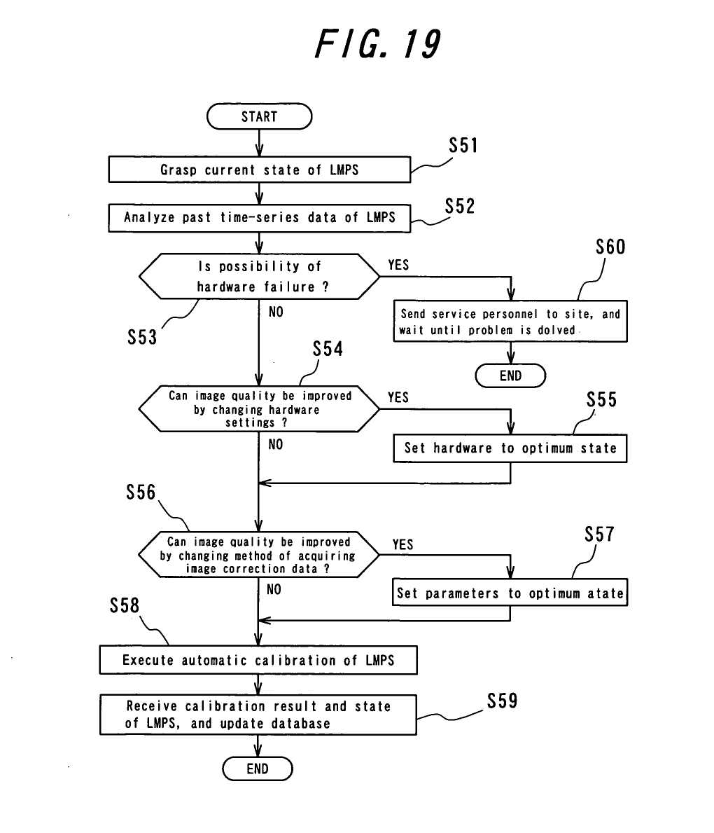

FIG. 19 is a flowchart showing an outline of an operation of the MPSCS 300 according to this embodiment, and illustrates an operation of acquiring image correction data which is used to analyze time-series data of the projector characteristics accumulated in the characteristic data accumulating section 313 in order to perform the automatic calibration.

First, a current state of the LMPS 100 which is a calibration target is grasped (step S51), past time-series data of this LMPS 100 accumulated in the characteristic data accumulating section 313 is analyzed (step S52), and a judgment is made upon whether there is a possibility of a hardware failure based on an analysis result (step S53).

Here, if it is determined that there is no possibility of a hardware failure (if NO), a judgment is made upon whether the image quality can be improved by changing the hardware setting (step S54). If the image quality can be improved (if YES), the hardware is set to the optimum state (step S55). Thereafter, a judgment is made upon whether the image quality can be improved by changing the method of acquiring image correction data (step S56). If the image quality can be improved (if YES), parameters are set to the optimum state (step S57).

When the image correction data is acquired in this manner, the automatic calibration is executed with respect to this LMPS 100 based on the acquired image correction data (step S58), various kinds of information indicative of a calibration result and state are received and the database is updated (step S59), thereby terminating the processing.

Incidentally, if it is determined that there is a possibility of a hardware failure at the step S53 (if YES), a service personnel is sent to a site to set this LMPS 100 which is maintained in the standby mode until the problem is solved (step S60), thereby terminating the processing.

As described above, the characteristic data accumulating section 313 is provided to the LMPS database section 311 of the analysis supporting section 303, past data of each LMPS 100, especially changes in luminance or color of each projector with time are continuously accumulated, and reference is made to the accumulated data when setting the calibration parameters. As a result, the LMPS analysis by the SI 306 can be efficiently supported.

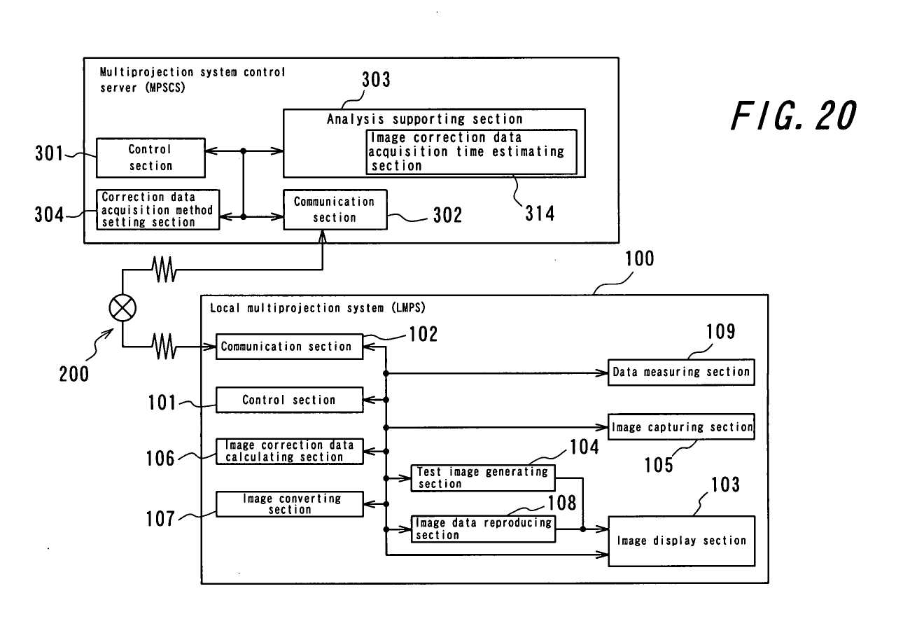

FIG. 20 is a block diagram showing a basic structure of an MPS according to a fifth embodiment of the present invention.

The MPS according to this embodiment has an image correction data acquisition time estimating section 314 being provided to the analysis supporting section 303 of the MPSCS 300 in the first embodiment, and this image correction data acquisition time estimating section 314 is used to estimate a time required to perform the calibration of the LMPS 100 as a calibration target.

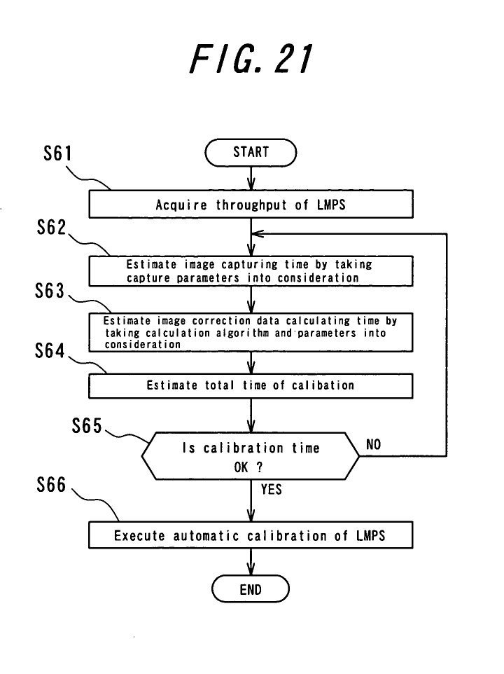

FIG. 21 is a flowchart showing an outline of an operation of the MPSCS 300 according to this embodiment, and illustrates an operation of acquiring image correction data which is used to perform the automatic calibration while taking an image correction data acquisition time into consideration.

First, a throughput of the LMPS 100 as a calibration target is acquired (step S61). This throughput is obtained by, e.g., allowing this LMPS 100 to perform a predetermined calculation and measuring its processing time.

Then, an image capture time is estimated while taking capture parameters in the image capturing section 105 of the LMPS 100 into consideration (step S62). As to this processing, a pre-scan capture (e.g., capturing test images of black and white alone) may be performed in the image capturing section 105 and a capture time of the overall calibration may be estimated from its capture time.

Thereafter, an image correction data calculation time is estimated while taking a calculation algorithm and parameters into consideration (step S63). As to this processing, a calculation may be performed with respect to one projector of the LMPS 100 and all image correction data calculation times may be estimated.

Upon terminating the above-described processing, a total time required for the calibration is estimated based on the obtained information (step S64), and whether this total time is OK is judged (step S65). If OK (if YES), the automatic calibration is executed (step S66). If not OK (if NO), the processing advances to the step S62, the various kinds of parameters are again examined, and the above-described processing is repeated.

By providing the image correction data acquisition time estimating section 314 and estimating a time required for the calibration while taking a capture time or a calculation time into consideration in this manner, the image correction data can be acquired within a time allowed for the calibration, and the automatic calibration can be efficiently performed.

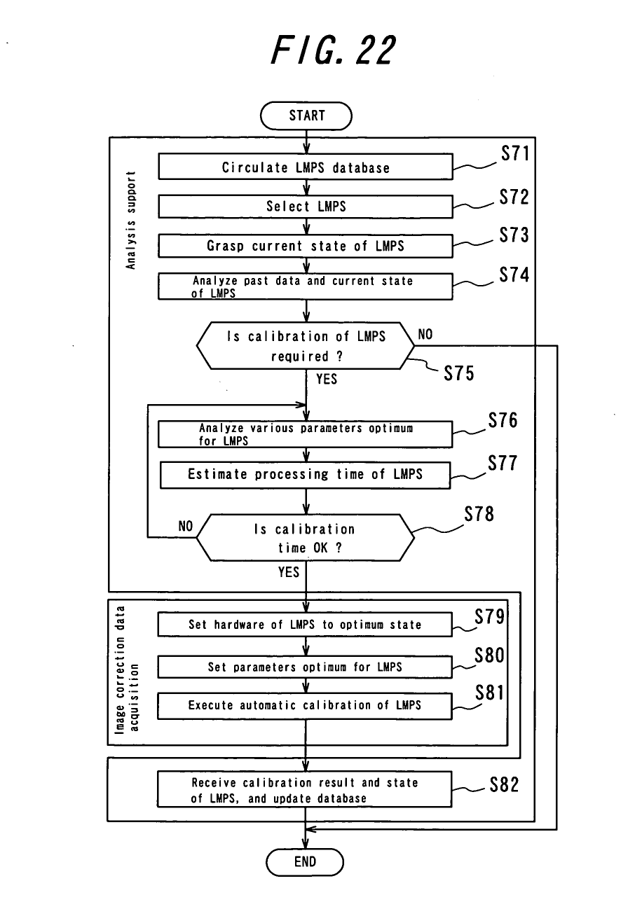

FIG. 22 is a flowchart showing an outline of an operation of an MPS according to a sixth embodiment of the present invention. The MPS according to this embodiment has the LMPS monitoring section 312 described in the third embodiment, the LMPS database section 311 having the characteristic data accumulating section 313 described in the fourth embodiment and the image correction data acquisition time estimating section 314 explained in the fifth embodiment being provided to the analysis supporting section 303 of the MPSCS 300 described in the first embodiment.

First, the LMPS database of the LMPS database section 311 is circulated (step S71), and an LMPS 100 as a calibration target is selected (step S72). Then, a current state of the selected LMPS 100 is grasped (step S73), past time-series data of this LMPS 100 accumulated in the characteristic data accumulating section 313 and the current state of the same are analyzed (step S74), and a judgment is made upon whether the calibration of the selected LMPS 100 is required based on an analysis result (step S75).

Here, if it is determined that the calibration is required, various kinds of parameters optimum for this LMPS 100 are analyzed (step S76), then a processing time required for the calibration is estimated (step S77), and a judgment is made upon whether the estimated processing time, i.e., a calibration time is OK (step S78). If it is not OK (if NO), the processing advances to the step S76, and the various kinds of parameters are again examined, and the above-described processing is repeated.

If the calibration time is OK (if YES) at the step S78, the hardware of the LMPS 100 is set to the optimum state based on the analysis result at the step S76 (step S79). At the same time, various kinds of parameters optimum for the LMPS 100 are set (step S80), and the automatic calibration of the LMPS 100 is executed (step S81). Thereafter, various kinds of information indicative of a calibration result and state from the LMPS 100 are received and the database is updated (step S82), thereby terminating the processing.

In FIG. 22, the steps S71 to S78 and the step S82 indicate the analysis supporting processing executed in the analysis supporting section 303, and the steps S79 to S81 indicate image correction data acquisition processing executed in the correction data acquisition method setting section 304.

As described above, according to this embodiment, since the LMPS monitoring section 312, the LMPS database section 311 having the characteristic data accumulating section 313, and the image correction data acquisition time estimating section 314 are provided to the analysis supporting section 303 of the MPSCS 300, various kinds of analysis supporting functions can be utilized when performing the calibration, and the calibration of the LMPS 100 can be more optimally carried out.

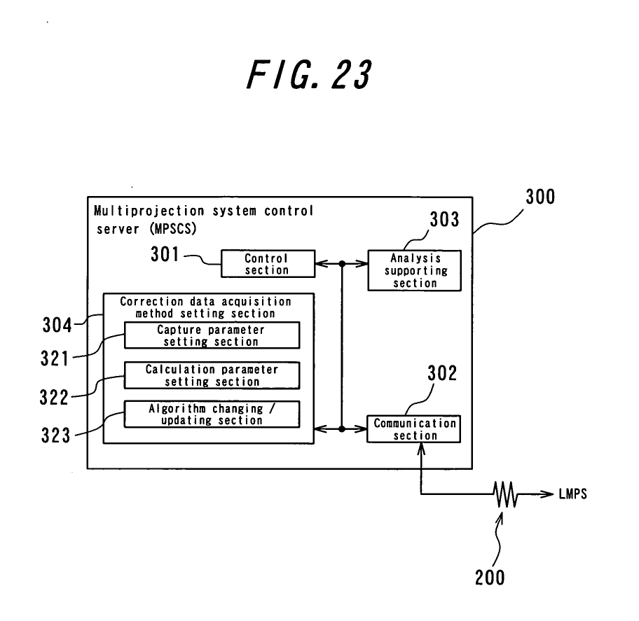

FIG. 23 is a block diagram showing a structure of a primary part of an MPS according to a seventh embodiment of the present invention.

In this embodiment, a capture parameter setting section 321 which sets capture parameters at the time of image correction data acquisition in the LMPS, a calculation parameter setting section 322 which sets parameters at the time of image correction data calculation, and an algorithm changing/updating section 323 as a calculation algorithm setting section which sets an algorithm at the time of the image correction data calculation are provided to the correction data acquisition method setting section 304 of the MPSCS 300 in the sixth embodiment.

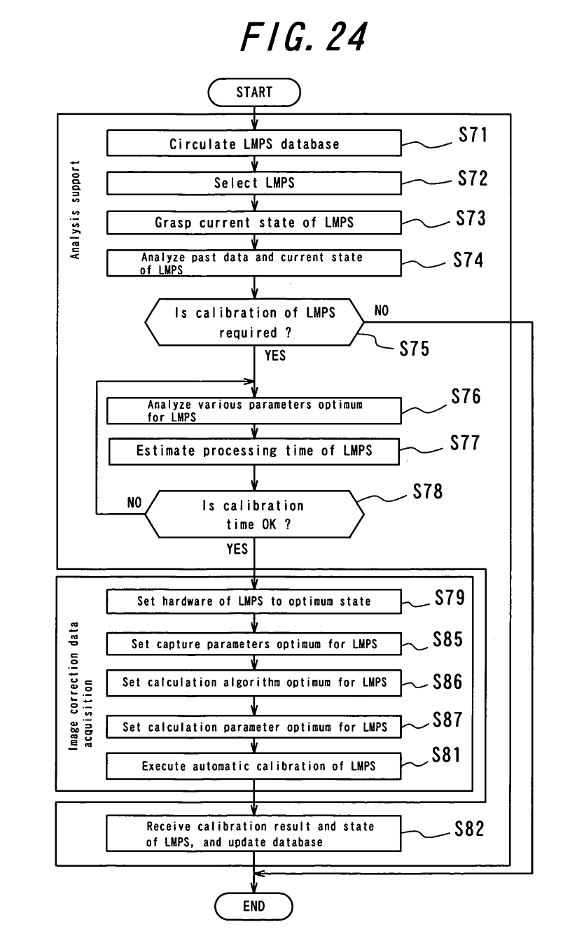

FIG. 24 is a flowchart showing an outline of an operation of the MPS according to this embodiment. Since this embodiment is different from the foregoing embodiment in processing at the step S80 in the flowchart illustrated in FIG. 22 but the same as FIG. 22 in any other processing, like step reference numerals denote processings equal to those in the FIG. 22, thereby eliminating the explanation thereof.

That is, in this embodiment, when a calibration time is OK at the step S78 and the hardware of the LMPS 100 is set to the optimum state at the step S79, capture parameters optimum for acquiring image correction data by the image capturing section 105 of the LMPS 100 are set in the capture parameter setting section 321 (step S85), a calculation algorithm optimum for calculating the image correction data from the image data obtained by capturing are set by the algorithm changing/updating section 323 (step S86), and calculation parameters optimum for calculating the image correction data are set by the calculation parameter setting section 322 (step S87), thereby executing the automatic calibration at the step S81.

By setting the capture parameters at the time of the image correction data acquisition by the image capturing section 105 of the LMPS 100 and the calculation parameters and the calculation algorithm at the time of the image correction data calculation and executing the calibration in this manner, a desired calibration can be performed without a need of sending the SI 306 to a site.

It is to be noted that the capture parameter setting section 321, the calculation parameter setting section 322 and the algorithm changing/updating section 323 are provided to the correction data acquisition setting section 304 in the seventh embodiment, but arbitrary one or two of these sections may be provided.

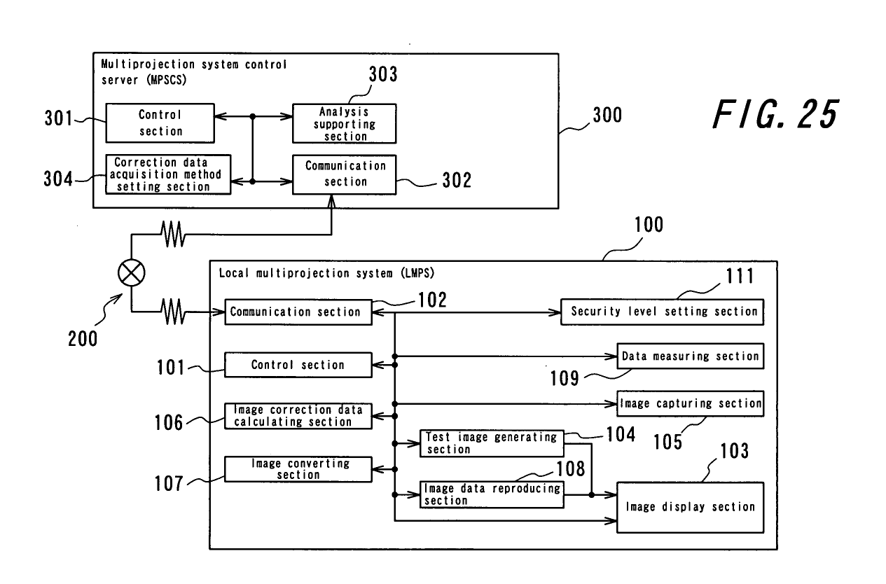

FIG. 25 is a block diagram showing a basic structure of an MPS according to an eighth embodiment of the present invention.

In this embodiment, a security level setting section 111 which arbitrarily sets a security level is provided to the LMPS 100 in each of the foregoing embodiments so that a network connection state can be changed in accordance with a security level set by this security level setting section 111.

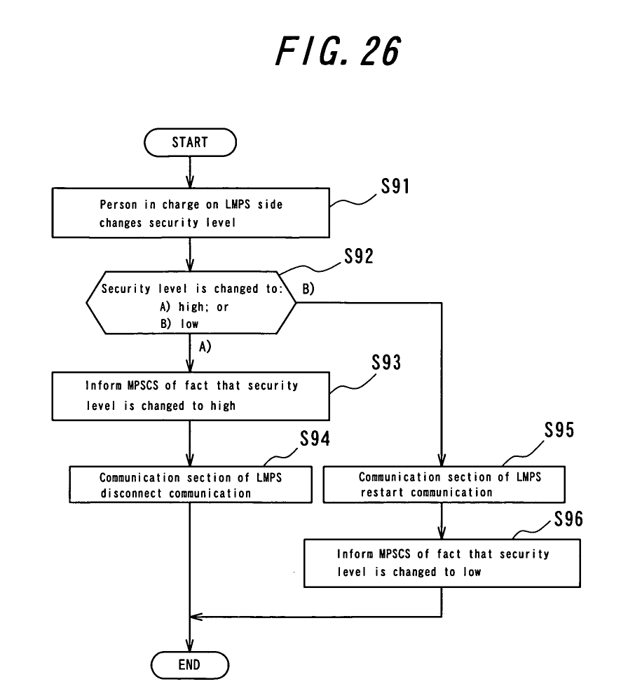

FIG. 26 is a flowchart showing an operation of a primary part of this embodiment, and illustrates an operation of switching a communication state of the LMPS 100 in accordance with a security level by using the security level setting section 111.

First, when a security level is changed by a person in charge on the LMPS 100 side (step S91), this change is detected (step S92). If the security level is changed to a higher level (in case of A), the MPSCS 300 is informed of this fact (step S93), and then the communication is disconnected by the communication section 102 (step S94). If the security is changed to a lower level (in case of B), the communication is restarted by the communication section 102 (step S95), and the MPSCS 300 is informed of this fact (step S96).

As described above, in this embodiment, since disconnection/restart of the communication with the MPSCS 300 can be controlled by changing a security level by the security level setting section 111 provided to the LMPS 100, monitoring on the MPSCS 300 side can be suppressed by changing the security level to, e.g., a higher level. As a result, a user of the LMPS 100 can process confidential information in the LMPS 100 and its periphery at ease without worrying out leakage of information to the MPSCS 300 side.

It is to be noted that the disconnection of the communication with the MPSCS 300 may be a disconnection on a protocol level or a physical disconnection. Additionally, the security level is not restricted to two levels, i.e., the disconnection and the restart of the communication, and more levels may be set in order to more finely suppress the communication. For example, when the communication is disconnected in accordance with a security level, when an operation of the image capturing section 105 or a data measuring operation is changed, or when the analysis supporting section 303 of the MPSCS 300 has the LMPS monitoring section 312 as shown in FIG. 16, transmission of information to the LMPS monitoring section 312 can be restricted.

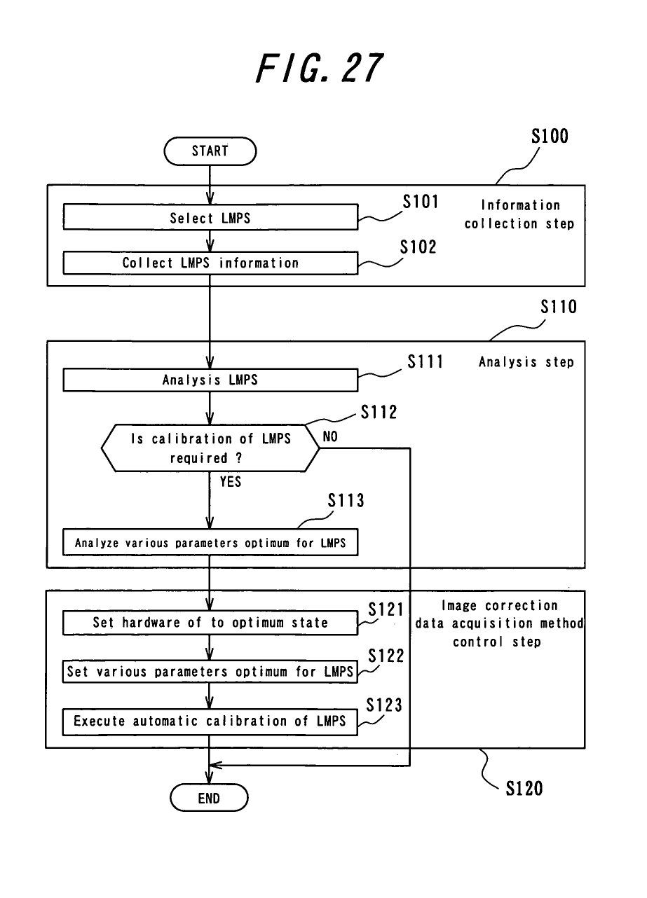

FIG. 27 is a flowchart showing an operation of a primary part in a ninth embodiment according to the present invention, and illustrates an operation when acquiring image correction data of each LMPS 100 on the MPSCS 300 side in each of the foregoing embodiments.

The image correction data acquisition operation in this embodiment has an information collection step (S100) of obtaining a state of the LMPS 100 through the network 200, an analysis step (S110) of analyzing the obtained current state, and an image correction data acquisition method control step (S120) of setting parameters optimum for the analyzed current state in order to execute the automatic calibration of the LMPS 100 through the network 200.

At the information collection step (100), first, a desired LMPS 100 is selected (step S101), and information of the selected LMPS 100 is collected (step S102). Then, at the analysis step (S110), a current state of this LMPS 100 is analyzed from the collected information (step S111), and a judgment is made upon whether the calibration of this LMPS 100 is necessary from an analysis result (step S112). If it is determined that the calibration is necessary, various kinds of parameters optimum for this LMPS 100 are analyzed (step S113), and the processing proceeds to the next image correction data acquisition method control step (S120).

At the image correction data acquisition method control step (S120), the hardware of the LMPS 100 is set to the optimum state based on an analysis result at the analysis step (S110) (step S121), various kinds of parameters optimum for the LMPS 100 are set (step S122), and the automatic calibration of the LMPS 100 is executed (step S123), thereby terminating the processing. Incidentally, if it is determined that the calibration is not necessary at the analysis step (S110), the processing is terminated without executing the image correction data acquisition method control step (S120).

According to this embodiment, since a state of a desired LMPS 100 can be analyzed from a remote site through the network 100, the calibration with a high accuracy and a high image quality can be executed without sending the SI 306 to the site.

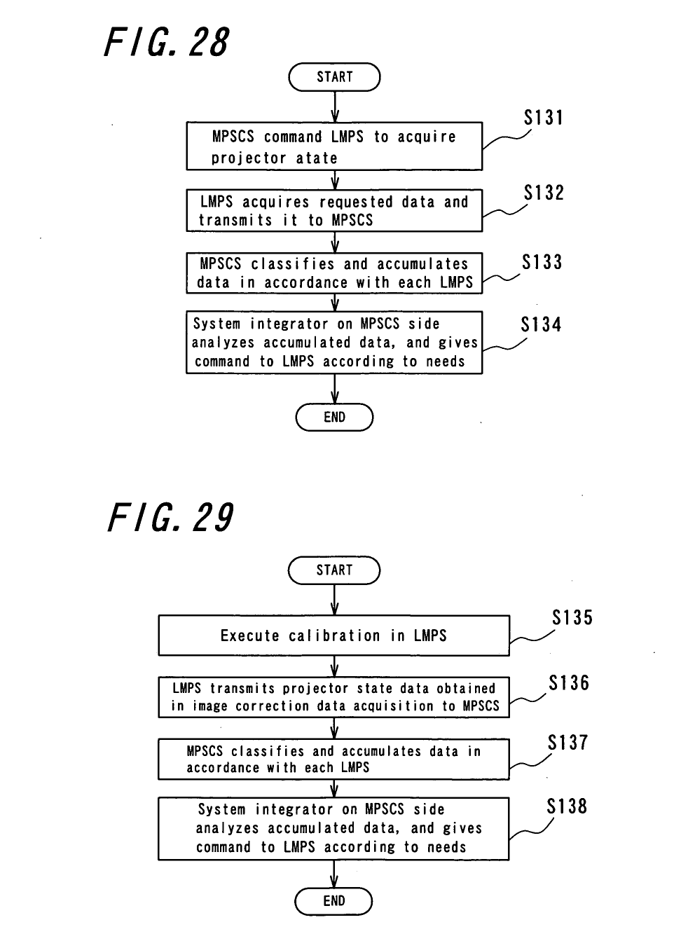

FIG. 28 is a flowchart showing an operation of a primary of in a 10th embodiment according to the present invention, and illustrates an operation when projector state data of each LMPS 100 is continuously accumulated with arbitrary timings in the MPSCS 300 in order to collect information of a desired LMPS 100 at the information collection step 100 according to the ninth embodiment mentioned above.

First, the MPSCS 300 commands each LMPS 100 to acquire projector state data (step S131). Here, the command with respect to the LMPS 100 may be issued by the SI 306 on the MPSCS 300 side or may be periodically automatically issued. Further, the projector state data includes, e.g., a luminance of each projector, each primary color luminance of RGB of each projector, a contrast of the entire system, each primary color chromaticity value of RGB of each projector, a y coefficient of each projector, in-plane color irregularities of each projector and others.

Subsequently, each LMPS 100 acquires requested data in response to the command from the MPSCS 300, and transmits it to the MPSCS 300 (step S132). Thereafter, the MPSCS 300 classifies and accumulates the received data in accordance with each LMPS (step S133).

When the projector state data of each LMPS 100 is continuously acquired in the MPSCS 300 in this manner, the analysis step (S110) shown in FIG. 27 is executed with respect to a desired LMPS 100. In this embodiment, however, as indicated by the step S134 in FIG. 28, a change with time in the projector state of each LMPS 100 is analyzed based on the accumulated data by the SI 306 on the MPSCS 300 side, a necessary command, e.g., a recommendation of execution of the calibration, a recommendation of replacement of the projector, a recommendation of replacement of the projector lamp or the like is given to this LMPS 100 according to needs.

By acquiring the projector state data of each LMPS 100 with an arbitrary timing and analyzing a change with time in this data, each LMPS 100 can be calibrated to an optimum state.

FIG. 29 is a flowchart showing an operation of a primary part in an 11th embodiment according to the present invention, and illustrates an operation when the projector state data explained in the 10th embodiment is acquired to be accumulated by the MPSCS 300 after execution of the calibration of the LMPS 100 in stead of an arbitrary timing.

In this embodiment, therefore, as shown in FIG. 29, when the calibration is executed in the LMPS 100 (step S135), the projector state data at the time of acquisition of the image correction data required to execute this calibration is transmitted from this LMPS 100 to the MPSCS 300 (step S136).

The MPSCS 300 classifies and accumulates the received data in accordance with each LMPS (step S137), analyzes aged changes in the projector state of each LMPS 100 based on the accumulated data by the SI 306, and issues a necessary command to this LMPS 100 according to needs like the 10th embodiment (step S138).

As described above, in this embodiment, since the projector state data of the LMPS 100 is acquired and its aged changes are analyzed every time the calibration is executed, each LMPS 100 can be calibrated to the optimum state like the 10th embodiment.

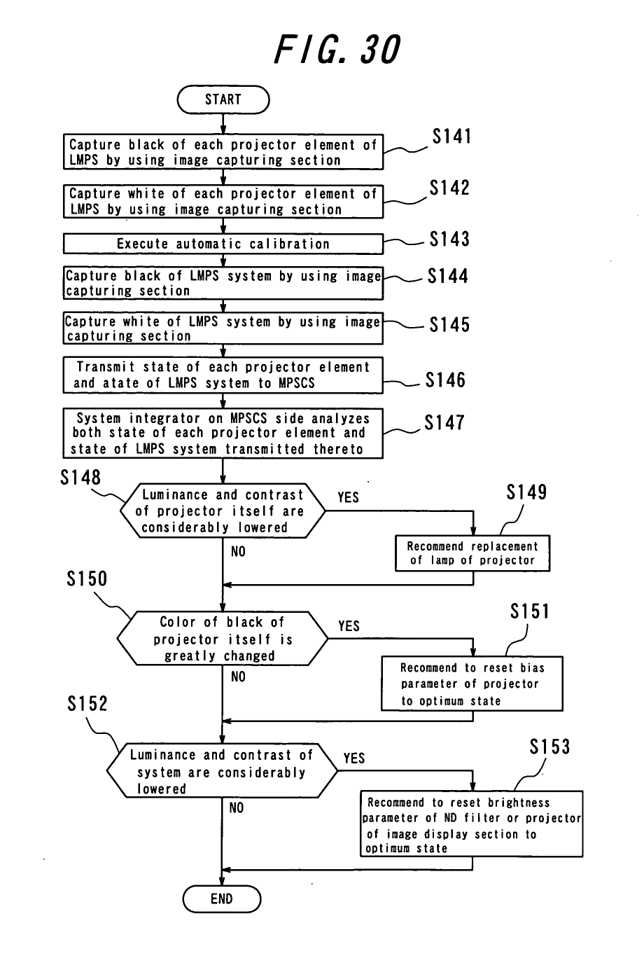

FIG. 30 is a flowchart showing an operation of a primary part in a 12th embodiment according to the present invention, and illustrates an operation when analyzing aged changes in luminance information of offset light and maximum light emission of each projector as the projector state data in the 11th embodiment.

First, in the LMPS 100, an image of the screen 115 when black and white are projected by each projector, i.e., black and white of each projector element are captured by using the image capturing section 105 (steps S141 and 142), and the automatic calibration is executed (step S143). Thereafter, an image of the screen 115 when black and white are projected by using all the projectors, i.e., black and white of the LMPS system are captured by using the image capturing section 105 (steps S144 and 145), a state of each projector element obtained at the steps S141 and 142 and a state of the LMPS system obtained at the steps S144 and 145 are transmitted to the MPSCS 300 (step S146).

On the MPSCS 300 side, the state of each projector element and the state of the LMPS system transmitted thereto are analyzed together with their data in the past by the SI 306 (step S147), and whether the luminance and the contrast of each projector element are considerably lowered is judged based on an analysis result (step S148). If they are considerably lowered (if YES), a command which recommends replacement of the lamp of the projector is transmitted to the corresponding LMPS 100 (step S149), and whether the color of black of each projector element is greatly changed is judged (step S150). If it is greatly changed (if YES), a command which recommends to reset a bias parameter of the projector to the optimum state is transmitted to the corresponding LMPS 100 (step S151), and whether the luminance and the contrast of the system are considerably lowered is judged (step S152). If they are considerably lowered (if YES), a command which recommends to reset a brightness parameter of the ND filter or the projector of the image display section 103 to the optimum state is transmitted to the corresponding LMPS 100 (step S153), thereby terminating the processing.

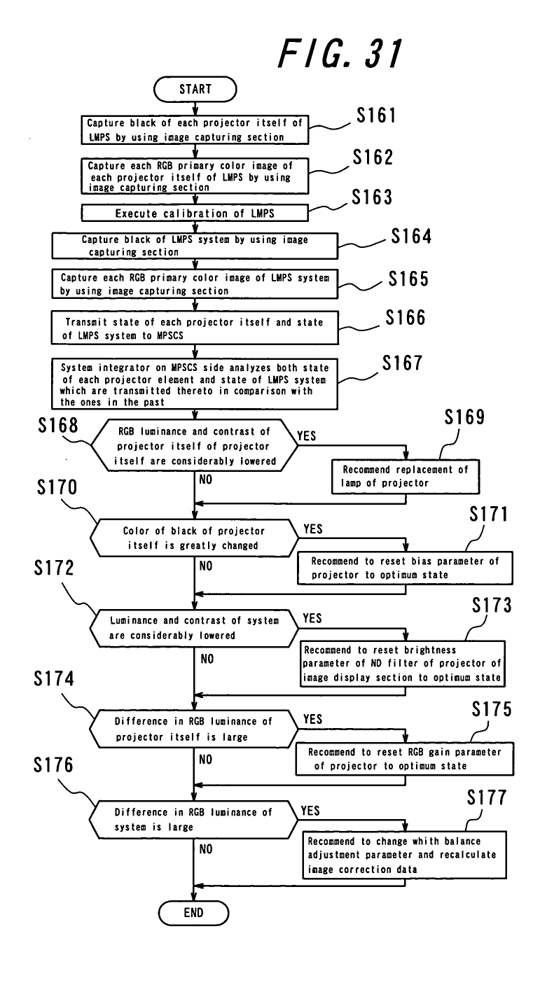

FIG. 31 is a flowchart showing an operation of a primary part in a 13th embodiment according to the present invention, and illustrates an operation when analyzing aged changes in luminance information of offset light and maximum light emission of each primary color of RGB of each projector as the projector state data in the 11th embodiment.

First, in the LMPS 100, images of black and each RGB primary color of each projector element are captured by using the image capturing section 105 (steps S161 and 162), and the calibration of the LMPS 100 is executed (step S163). Then, images of black and each RGB primary color of the LMPS system are captured by using the image capturing section 105 (steps S164 and 165), and a state of each projector element obtained at the steps S161 and 162 and a state of the LMPS system obtained at the steps S164 and 165 are transmitted to the MPSCS 300 (step S166).

On the MPSCS 300 side, the state of each projector element and the state of LMPS system transmitted thereto are analyzed together with their data in the past by the SI 306 (step S167), and whether the RGB luminance and the contrast of each projector element are considerably lowered is judged based on an analysis result (step S168). If they are considerably lowered (if YES), a command which recommends replacement of the lamp of the projector is transmitted to the corresponding LMPS 100 (step S169), and whether the color of black of the projector element is greatly changed is judged (step S170). If it is considerably changed (if YES), a command which recommends to reset a bias parameter of the projector to the optimum state is transmitted to the corresponding LMPS 100 (step S171), and a judgment is made upon whether the luminance and the contrast of the system are considerably lowered (step S172). If they are considerably lowered (if YES), a command which recommends to reset a brightness parameter of the ND filter or the projector of the image display section 103 to the optimum state is transmitted to the corresponding LMPS 100 (step S173).

Further, a judgment is made upon whether a difference in RGB luminance of the projector elements is large based on the analysis result obtained at the step S167 (step S174). If it is large (if YES), a command which recommends to set an RGB gain parameter of the projector to the optimum state is transmitted to the corresponding LMPS 100 (step S175), and a judgment is made upon whether a difference in RGB luminance of the system is large (step S176). If it is large (if YES), a command which recommends to change a white balance adjustment parameter and recalculate the image correction data is transmitted to the corresponding LMPS 100 (step S177), thereby terminating the processing.

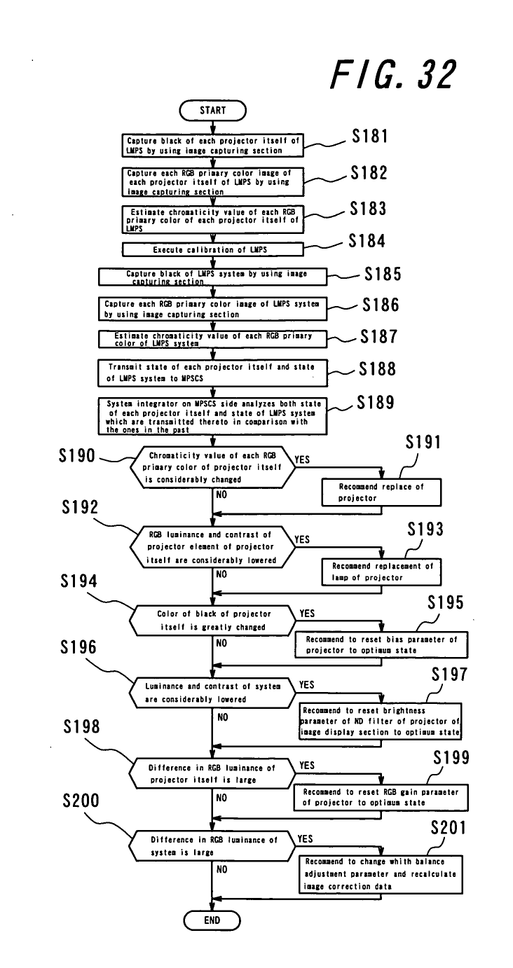

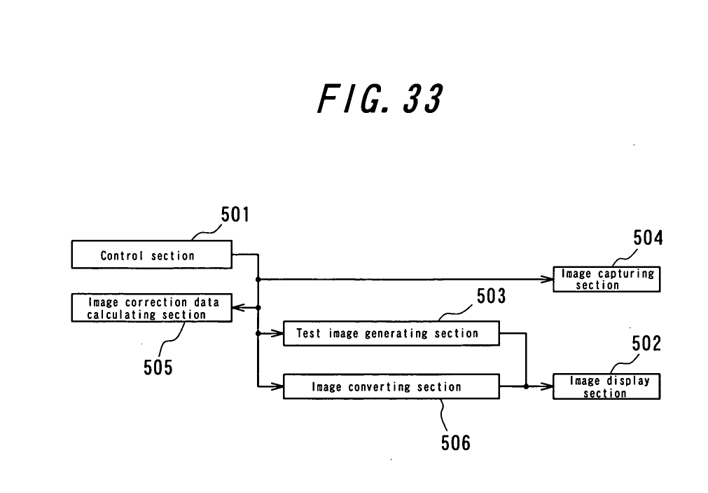

FIG. 32 is a flowchart showing an operation of a primary part in a 14th embodiment according to the present invention, and illustrates an operation when analyzing aged changes in chromaticity value information of offset light and maximum light emission of each RGB primary color of each projector as the projector state data in the 11th embodiment.

First, in the LMPS 100, images of black and each RGB primary color of each projector element are captured by using the image capturing section 105 (step S181 and 182), a chromaticity value of each RGB primary color of each projector element is estimated based on the captured images (step S183), and the calibration of the LMPS 100 is executed (step S184). Subsequently, images of black and each RGB primary color of the LMPS system are captured by the image capturing section 105 (steps S185 and 186), a chromaticity value of each RGB primary color of the LMPS system is estimated (step S187), and a state of each projector element obtained at the steps S181, 182 and 183 and a state of the LMPS system obtained at the steps S185, 186 and 187 are transmitted to the MPSCS 300 (step S188).

On the MPSCS 300 side, the state of each projector element and the state of the LMPS system transmitted thereto are analyzed together with their past data by the SI 306 (step S189), and a judgment is made upon whether the chromaticity value of each RGB primary color of each projector element is greatly changed based on an analysis result (step S190). If it is greatly changed (if YES), a command which recommends replacement of the projector is transmitted to the corresponding LMPS 100 (step S191). Here, as to replacement of the projector, if a part which determines a chromaticity value of each primary color of the projector can be replaced like an LD panel of an LCD projector, this part may be replaced.

Furthermore, a judgment is made upon whether an RGB luminance and a contrast of each projector element are considerably lowered based on the analysis result obtained at the step S189 (step S192). If they are considerably lowered (if YES), a command which recommends replacement of the lamp of the projector is transmitted to the LMPS 100 (step S193), and whether the color of black of each projector element is greatly changed is judged (step S194). If it is greatly changed (if YES), a command which recommends to reset a bias parameter of the projector to the optimum state is transmitted to the LMPS 100 (step S195), and whether a luminance and a contrast of the system are considerably lowered is judged (step S196). If they are considerably lowered (if YES), a command which recommends to reset a brightness parameter of the ND filter or the projector of the image display section 103 to the optimum state is transmitted to the corresponding LMPS 100 (step S197).

Moreover, whether a difference in RGB luminance of the projector elements is large is judged based on the analysis result obtained at the step S189 (step S198). If it is large (if YES), a command which recommends to set an RGB gain parameter of the projector to the optimum state is transmitted to the corresponding LMPS 100 (step S199), and a judgment is made upon whether a difference in RGB luminance of the system is large (step S200). If it is large (if YES), a command which recommends to change a white balance adjustment parameter and recalculate image correction data is transmitted to the LMPS 100 (step S201), thereby terminating the processing.

As apparent from the 12th to 14th embodiments, the LMPS 100 can be analyzed from various view points in accordance with a content of data accumulated as the projector state data, and the method of acquiring the image correction data can be optimally set based on an analysis result.

It is to be noted that the description has been given as to the example in which the LMPS 100 has two right and left projectors 112 and 113 in the foregoing embodiments, but the present invention can be also effectively applied to an example in which a total of four projectors, i.e., two right and left projectors on each of upper and lower stages are provided or an example in which more projectors are provided.

As described above, according to the present invention, the LMPS and the MPSCS are connected through the network 200, the analysis supporting section which supports analysis of a state of the LMPS and the correction data acquisition method setting section which sets the correction data acquisition method in the LMPS are provided to the MPSCS, so that a state of the LMPS is analyzed by the analysis supporting section and a correction data acquisition method of the LMPS is set based on an analysis result by the correction data acquisition method setting section in order to execute the automatic calibration of the LMPS through the network. Therefore, the calibration of the LMPS can be efficiently rapidly carried out without a need of sending the SI to a user side each time, thereby reducing an operation cost.

1. A multiprojection system which has a local multiprojection system which projects one image on a screen by using a plurality of projectors and a multiprojection system control server connected to the local multiprojection system through a network,
the multiprojection system control server comprising:
an analysis supporting section which supports analysis of a state of the local multiprojection system; and
a correction data acquisition method setting section which sets a method of acquiring correction data in the local multiprojection system,
wherein, in a state that the multiprojection system control server is connected with the local multiprojection system through the network, a state of the local multiprojection system is analyzed by the analysis supporting section, a method of acquiring correction data of the local multiprojection system is set based on an analysis result by the correction data acquisition method setting section, and automatic calibration is executed.

2. The multiprojection system according to claim 1, wherein the analysis supporting section comprises:
user information including an installation position of the local multi-projection system and a user; and
a database section which stores local multiprojection system configuration information including a projector model, the number of projectors, a projector layout, a screen size, a screen shape, a projection way and hardware information.

3. The multiprojection system according to claim 1, wherein the analysis supporting section comprises a local multiprojection system monitoring section which can monitor an operating status, a state and a circumferential environment of the local multiprojection system.

4. The multiprojection system according to claim 2, wherein the database section comprises a local multiprojection system data accumulating section which continuously accumulates aged changes in projector characteristics in the local multiprojection system so that reference can be made to the projector characteristics.

5. The multiprojection system according to claim 1, wherein the analysis supporting section comprises an image correction data acquisition time estimating section which estimates a time required for calibration of the local multiprojection system.

6. The multiprojection system according to claim 1, wherein the correction data acquisition method setting section comprises a capture parameter setting section which sets capture parameters at the time of acquisition of image correction data in the local multiprojection system.

7. The multiprojection system according to claim 1, wherein the correction data acquisition method setting section comprises a calculation algorithm setting section which sets an image correction data calculation algorithm in the local multiprojection system.

8. The multiprojection system according to claim 1, wherein the correction data acquisition method setting section comprises a calculation parameter setting section which sets parameters for image correction data calculation in the local multiprojection system.

9. The multiprojection system according to claim 1, wherein the local multiprojection system comprises a security level setting section so that a network connection state can be changed in accordance with a security level set in the security level setting section.

10. A method of acquiring image correction data in a multiprojection system, comprising:
an information collection step of collecting through a network a state of a local multiprojection system which displays a still picture or a moving picture corresponding to an input image signal on a screen by using images projected by a plurality of projectors;
an analysis step of analyzing an acquired current state; and
an image correction data acquisition method control step of setting parameters optimum for the analyzed current state and executing automatic calibration of the local multiprojection system through the network.

11. The method of acquiring image correction data in a multiprojection system according to claim 10, wherein a state and characteristics of the local multiprojection system including at least projector characteristics of the local multiprojection system are continuously accumulated at the information collection step, and
the analysis step includes an accumulated data analysis step of analyzing a current state based on the continuously accumulated projector characteristics.

12. The method of acquiring image correction data in a multiprojection system according to claim 11, wherein the projector characteristics acquired at the information collection step include luminance information of offset light and maximum light emission of the projector, and
aged changes in the luminance information of offset light and maximum light emission are analyzed at the accumulated data analysis step.

13. The method of acquiring image correction data in a multiprojection system according to claim 11, wherein the projector characteristics acquired at the information collection step include luminance information of offset light and maximum light emission of each RGB primary color of the projector, and
aged changes in the luminance information of offset light and maximum light emission of each RGB primary color are analyzed at the accumulated data analysis step.

14. The method of acquiring image correction data in a multiprojection system according to claim 11, wherein the projector characteristics acquired at the information collection step include chromaticity value information of offset light and maximum light emission of each RGB primary color of the projector, and
aged changes in the chromaticity value information of offset light and maximum light emission of each RGB primary color are analyzed at the accumulated data analysis step.
